(19) United States
(12) Patent Application Publication
(10) Pub. No.: US 2009/0044017 A1
(43) Pub. Date: Feb. 12, 2009

(54) SIGNATURE AND VERIFYING METHOD, AND SIGNATURE AND VERIFYING DEVICE

(75) Inventors: Isamu Teranishi, Tokyo (JP); Kazue Sako, Tokyo (JP); Daigo Taguchi, Tokyo (JP); Jun Noda, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 11/719,798

(22) PCT Filed: Nov. 11, 2005
(86) PCT No.: PCT/JP05/20729

§ 371 Date: May 21, 2007

(30) Foreign Application Priority Data
Nov. 29, 2004 (JP) 2004-343703

(51) Int. Cl. H04L 9/32; G09C 1/00

(52) U.S. Cl. 713/176

(57) ABSTRACT

An RSA signature method is provided in which the length of a signature does not depend on the number of signature devices when multiple signature devices are related to the creation of the signature. A signature device i_{m} includes first conversion means SS1B105 that performs no operation if a received signed text u_{i_{m−1}} exceeds a modulus n_{i_{m}} and, if not, adds an RSA-method-based signature; bijective conversion means S1B106 that multiplies the result by a function that maps the result to a value larger by the modulus n_{i_{m}}; second conversion means S1B107 that performs no operation if the operation result exceeds the modulus n_{i_{m}} and, if not, adds an RSA-method-based signature; and output means S1B109 that outputs the operation result as the signed text u_{i_{m}}.

### TECHNICAL FIELD

The present invention relates to a signature method and verification method and a signature device and verification device, and more particularly, to a signature method and verification method and a signature device and verification device where the signature length does not depend on the number of signature devices when a plurality of signature devices are used for signatures.

### BACKGROUND ART

As computers and the Internet environment are widely used, more and more messages are sent and received electronically. In this case, it is desirable that an electronic signature be added to a message to prevent the message from being altered while the message is sent.

However, when multiple signature devices create signatures using a well-known signature method such as RSA or DSA, all signature devices must individually create signed texts and save all those signed texts to indicate that all signature devices have signed. Therefore, because the total data length of the signed texts is proportional to the number of signature devices, the efficiency is degraded when there are many signature devices.

One of the signature methods to solve this problem is proposed in non-Patent Document 1. FIG. 11 shows the procedure for this conventional signature method.

The following defines the meaning of the symbols used in this specification. “∥” means the concatenation of bit strings. “◯” means the exclusive OR on a bit basis. “̂” represents the arithmetic operator for exponentiating the left operand by the exponent in the right operand. For example, f̂{−1} means f⁻¹. “_{x}” represents that x is a subscript. For example, u_{i} means uᵢ.

Referring to FIG. 11, when a signed text u_{i_{m−1}} to be signed is entered (S3F100), the verification of the validity of the key owned (S3F101) and the verification of the validity of the signed text u_{i_{m−1}} (S3F102) are performed and, after that, T_{m}, which is the concatenation of the public key of the local signature device and the public keys of the signature devices that have already signed, is calculated (S3F103). Next, the exclusive OR U between the hash value of T_{m} and the signed text u_{i_{m−1}} is calculated (S3F104), the first k security parameter bits of the bit string U are assigned to a, and the remaining bits are assigned to s (S3F105). Next, a is compared with the RSA modulus n_{i_{m}} of the local signature device (S3F106) and, if a is smaller than the RSA modulus n_{i_{m}}, the signed text u_{i_{m})} is calculated for a using the private key d_{i_{m}} according to the RSA method (S3F107), and the result is output (S3F109). At this time, one-bit information 0 is added to s as the control information. If a is larger than the RSA modulus n_{i_{m}}, the RSA signature cannot be calculated for a number larger than the modulus and, therefore, n_{i_{m}} is subtracted from a, the signed text u_{i_{m}} is calculated for the resulting a (S3F108), and the result is output (S3F109). At this time, one-bit information 1 is added to s as the control information.

The signature cannot be calculated for a number larger than the RSA modulus n_{i_{m}} of a signature device when RSA is used as described above. To solve this problem, the method according to the conventional technology described in the Non-Patent Document 1 subtracts the modulus n_{i_{m}} from a number, which is larger, before the signature is added. At this time, to allow the verification to be performed later, one-bit control information (1 when the modulus is exceeded, and 0 when the modulus is not exceeded) is added at the end. When the signed text u_{i_{m}} is verified, the verification is repeated by using the public keys of the signature devices in reverse order of adding signatures and, when the predetermined initial value is finally obtained, the signatures are determined to be valid.

### [Non-Patent Document 1]

Anna Lysyanskaya, Silvio Micali, Leonid Reyzin, Hovav Shacham. Sequential Aggregate Signatures from Trapdoor Permutations. In Advances in Cryptology—EUROCRYPT 2004, vol. 3027 of LNCS, pp. 74-90. Springer-Verlag, 2004.

### [Non-Patent Document 2]

“Alfred J. Menezes Paul C. van Oorschot, and Scott A. Vanstone. Handbook of Applied Cryptography. CRC Press.” (http://www.cacr.math.uwaterloo.ca/hac/).

### DISCLOSURE OF THE INVENTION

### Problems to be Solved by the Invention

The conventional signature method described in Non-Patent Document 1, in which the total data length of signed texts is not proportional to the number of signature devices, can reduce the amount of memory for storing signed texts even if multiple signature devices add signature sequentially and can reduce the amount of communication when communication is performed. However, because the signature length is determined by the fixed value+number of signatures, the problem is that the signature length is prolonged, though little by little, as the number of signatures increases.

It is an object of the present invention to improve the problems with the conventional signature method described above and to make the signature fixed-length regardless of the number of signature devices.

### Means to Solve the Problems

A signature method according to claim 1 is a signature method for use by a signature device that receives an initial value or a signed text, which is created by sequentially performing a signature operation by other plurality of signature devices, messages, and a private key of said signature device and that outputs a signed text equal in length to an input, wherein said output signed text indicates that the signature devices concerned with the creation of said output signed text, have signed the message input to each of the signature devices.

A signature method according to claim 2 is the signature method as defined by claim 1 wherein an operation of calculating the signed text has a first step and a second step, an inverse function of a trapdoor one-way replacement is used for a calculation of the first step (operation of a part indicated by f̂{−1}), an inverse function of a trapdoor one-way replacement that is the same as, or different from, the trapdoor one-way replacement in the first step is used for a calculation of the second step (operation of a part indicated by ĥ{−1}), a calculation result is stored into a storage medium after the first step is terminated, necessary data is read from the storage medium when the second step is started, and a calculation result is stored in the storage medium after the second step is terminated.

A signature method according to claim 3 is the signature method as defined by claim 2 wherein, if an input to the first step is an element of a range of the trapdoor one-way replacement, the input is mapped by the inverse function of the trapdoor one-way replacement but, if not, no operation is performed and wherein, if an input to the second step is an element of a range of the trapdoor one-way replacement, the input is mapped by the inverse function of the trapdoor one-way replacement but, if not, no operation is performed.

A signature method according to claim 4 is the signature method as defined by claim 3 wherein the calculation of the trapdoor one-way replacement used in the second step further comprises a first sub-step and a second sub-step, wherein, in the first sub-step (operation of a part indicated by (φ̂{−1}), a bijection in a space of a whole signed text is calculated, the bijection can be calculated in polynomial time, and an inverse function of the bijection can also be calculated in polynomial time and, in the second sub-step (operation of a part indicated by ĝ{−1}), the inverse function of the trapdoor one-way replacement is used and, if an input to the second sub-step is an element of a range of the trapdoor one-way replacement, the input is mapped by an inverse function of the trapdoor one-way replacement but, if not, no operation is performed, and wherein necessary data is read from the storage medium when the first sub-step and the second sub-step are started and a calculation result is written into the storage medium when the first sub-step and the second sub-step are terminated.

A signature method according to claim 5 is the signature method as defined by claim 4 wherein the trapdoor one-way replacement used in the first step and the trapdoor one-way replacement used in the second sub-step of the second step are RSA functions.

A signature method according to claim 6 is the signature method as defined by claim 5 wherein the bijection used in the first sub-step of the second step is expressed as φ(x)=x−n_{i_{m}} mod 2̂{κ} here the n_{i_{m}} is an RSA modulus that is a part of a public key of the signature device i_{m} and the κ is a security parameter.

A signature method according to 7 is the signature method as defined by claim 6 wherein the first step is preceded by a T_{m} calculation step in which T_{m}=M_{—}{1}∥ . . . ∥M_{m}∥pk_{i_{—}{1}}∥ . . . ∥pk_{i_{m}} is calculated where, for each j, the M_{—}{1}, . . . , M_{j} are messages input to a j-th signature device and the pk_{i_{j}} is a public key of a signature device i_{j}.

A signature method according to claim 8 is the signature method as defined by claim 7 wherein the first step is preceded by an exclusive OR calculation step in which U=H(T_{m})◯u_{i_{i_{m−1}} is calculated where the H is a hash function, the u_{i_{m−1}} is the entered signed text, and ◯ is an exclusive OR.

A signature method according to claim 9 is the signature method as defined by claim 8 wherein the first step is preceded by a key validity verification step in which a check is made if pk_{i_{—}{1}}, . . . , pk_{i_{m−1}} are all different except when m=1 in which case no check is made.

A signature method according to claim 10 is the signature method as defined by claim 9 wherein the first step is preceded by a signed text verification step in which a received signed text is verified.

A signature method according to claim 11 is the signature method as defined by claim 8 wherein the first step is preceded both by a key validity verification step in which a check is made if pk_{i_{—}{1}}, . . . , pk_{i_{m−1}} are different and by a signed text verification step in which a received signed text is verified.

A signature method according to claim 12 is the signature method according to any one of claims 1-11, further comprising the step of creating the initial value or the signed text, which is input, or a hash value thereof as auxiliary information that is output on the storage medium, wherein the auxiliary information and the signed text are output as a pair.

A signature method according to claim 13 is a signature method comprising the steps of receiving, by input means, an initial value or a signed text u_{i_{m−1}}, which is created by other plurality of signature devices that sequentially perform a signature operation, and messages M_{—}{1}, . . . , M_{m−1} entered into the signature devices and saving the initial value or the signed text and the messages into a storage medium; reading, by T_{m} calculation means, necessary data from the storage medium and a public key storage device, calculating T_{m}=M_{—}{1}∥ . . . ∥M_{m}∥pk_{i_{—}{1}}∥ . . . ∥pk_{i_{m}} where pk_{i_{j}} is a public key of a signature device i_{j} and ∥ is a concatenation of bit strings, and saving the calculation result into the storage medium; reading, by exclusive OR calculation means, necessary data from the storage medium, calculating U=H(T_{m})◯u_{i_{m−1}} where H is a hash function and ◯ is an exclusive OR, and saving the calculation result into the storage medium; reading, by first conversion means, necessary data from the storage medium, calculating v=û{d_{i_{m}}} mod n_{i_{m}} if U<n_{i_{m}} where n_{i_m}} is an RSA modulus of the signature device, calculating v=U if U≧n_{i_{m}}, and saving the calculation result into the storage medium; reading, by bijective conversion means, necessary data from the storage medium, calculating v′=v+n_{i_{m}} mod 2̂{κ} where κ is a security parameter, and saving the calculation result into the storage medium; reading, by second conversion means, necessary data from the storage medium, calculating u_{i_{m}}=v′̂{d_{i_{m}}} mod n_{i_{m}} if v′<n_{i_{m}}, calculating u_{i_{m}}=v′ if v′≧n_{i_{m}}, and saving the calculation result into the storage medium; and reading, by output means, u_{i_{m}} from the storage medium and outputting u_{i_{m}} as the signed text.

A signature method according to claim 14 is the signature method as defined by claim 13, further comprising the step of:

calculating, by w setting means, w_{i_{m}}=u_{i_{m−1}} or w_{i_{m}}=h(u_{i_{m−1}}) where h is a hash function and saving the calculation result into the storage medium, wherein the created signed text u_{i_{m}}, which is paired with the calculated w_{i_{m}, is output with w_{i_{m}} as auxiliary information.

A verification method according to claim 15 is a verification method for use by a verification device that verifies if a signed text u, which is created by sequentially performing a signature operation by a plurality of signature devices, wherein the verification is passed when and only when the signed text U is created by signature devices, which have been concerned with a creation of the signed text that is output, that have signed the message entered into each of the signature devices and wherein a number of bits of the signed text u is a constant that does not depend on a number of the signature devices which have been concerned with a calculation of the signed text u.

A verification method according to claim 16 is a verification method for use by a verification device that verifies if a signed text u, which is created by sequentially performing a signature operation by a plurality of signature devices, wherein the verification is passed when and only when the signature devices, which create the signed text u, create the signed text u in a valid method, wherein a number of bits of the signed text u is a constant that does not depend on a number of the signature devices which have been concerned with a calculation of the signed text u, and wherein the verification of the signed text u is performed using auxiliary information w that is data before a last one of the plurality of signature devices performs the signature operation.

A verification method according to claim 17 is the verification method as defined by claim 15 or 16 wherein an operation of verifying the signed text has a first step and a second step, a trapdoor one-way replacement is used for a calculation of the first step (operation of a part indicated by h), a trapdoor one-way replacement that is the same as, or different from, the trapdoor one-way replacement in the first step is used for a calculation of the second step (operation of a part indicated by f), necessary data is read from a storage medium when the first step and the second step are started, and a calculation result is written into the storage medium when the first step and the second step are terminated.

A verification method according to claim 18 is the verification method as defined by claim 17 wherein, in the first step, if an input to the first step is an element of a domain of the trapdoor one-way replacement, the input is mapped by the trapdoor one-way replacement but, if not, no operation is performed and wherein, if an input to the second step is an element of a domain of the trapdoor one-way replacement, the input is mapped by the trapdoor one-way replacement but, if not, no operation is performed.

A verification method according to claim 19 is the verification method as defined by claim 18 wherein the calculation of the trapdoor one-way replacement used in the first step further comprises a first sub-step and a second sub-step, wherein, in the first sub-step (operation of a part indicated by g), a trapdoor one-way replacement function is used and, if an input to the first sub-step is an element of a range of the trapdoor one-way replacement, the input is mapped by the trapdoor one-way replacement function but, if not, no operation is performed, wherein, in the second sub-step (operation of a part indicated by φ), a bijection in a space of a whole signed text is calculated, the bijection can be calculated in polynomial time, and an inverse function of the bijection can also be calculated in polynomial time, and wherein necessary data is read from the storage medium when the first sub-step and the second sub-step are started and a calculation result is written into the storage medium when the first sub-step and the second sub-step are terminated.

A verification method according to claim 20 the verification method as defined by claim 19 wherein the trapdoor one-way replacement used in the first sub-step of the first step and the trapdoor one-way replacement used in the second step are RSA functions.

A verification method according to claim 21 is the verification method as defined by claim 20 wherein the bijection used in the second sub-step of the first step is expressed as φ(x)=x+n_i_{m} mod 2̂{κ} where the n_{i_{m}} is an RSA modulus that is a part of a public key of the signature device i_{m} and the κ is a security parameter.

A verification method according to claim 22 is the verification method as defined by claim 21 wherein the first step is followed by a T_{j} calculation step in which T_{j}=M_{—}{1}∥ . . . ∥M_{j}∥pk_{i_{—}{1}}∥ . . . ∥pk_{i_{j}} is calculated where, for each j, the M_{—}{1}), . . . , M_{j} are messages input to a j-th signature device and the pk_{i_{j}} is a public key of a signature device i_{j}.

A verification method according to claim 23 is the verification method as defined by claim 22 wherein the T_{j} calculation step is followed by a u calculation step in which necessary data is read from the storage medium, u_{i_{j−1}}=H{T_{j}}◯U is calculated, and the calculation result is saved into the storage medium where H is a hash function and U is the calculation result of the second step.

A verification method according to claim 24 is the verification method as defined by claim 23 wherein the first step, the second step, the T_{j} calculation step, and the u calculation step are repeated for j=m−1, . . . , 1.

A verification method according to claim 25 the verification method as defined by claim 24 wherein the first step, the second step, the T_{j} calculation step, and the u calculation step, which are repeated for j=m−1, . . . , 1, are preceded by a key validity verification step in which a check is made if pk_{i_{—}{1}}, . . . , pk_{i_{m−1}} are all different except when m=1 in which case no check is made.

A verification method according to claim 26 is the verification method as defined by claim 25 wherein the first step, the second step, the T_{j} calculation step, and the u calculation step, which are repeated for j=m−1, . . . , 1, are followed by a u checking step in which a check is made if an initial value is obtained as a result of the verification.

A verification method according to claim 27 the verification method as defined by claim 21 wherein the first step is preceded by a T_{m−1} calculation step and a v″ calculation step, T_{m−1}=M_{—}{1}∥ . . . ∥M_{m−1}∥pk_{i_{—}{1}}∥ . . . ∥pk_{i_{m−1}} is calculated in the T_{m−1} calculation step where M_{—}{1}, . . . , M_{m−1} are messages input to first, . . . , (m−1)th signature devices and the pk_{i_{j}} is a public key of a signature device i_{j}, and v″=H(T_{m−1})◯u_{i_{m−1}} is calculated in the v′ calculation step and wherein the first step receives the v′ and the second step is followed by a u checking step in which a check is made if a calculation result of the second step matches the auxiliary information.

A verification method according to claim 28 is a verification method comprising the steps of receiving, by input means, a signed text u_{i_{m−1}}, which is created by one or more other signature devices that sequentially perform a signature operation, messages M_{—}{1}, . . . , M_{m−1} entered into the signature devices, and public keys pk_{i_{—}{1}}, . . . , pk_{i_{m−1}} and saving the signed text, the messages, and the public keys into a storage medium; setting, by j initialization means, m−1 in a variable j; reading, by second conversion means, necessary data from the storage medium, calculating v′=u_{i_{j}}̂{e_{i_{j}}} mod n_{i_{j}} if u_{i_{j}}<n_{i_{j}}, calculating v′=u_{i_{j} if u_{i_{j}}≧n_{i_{j}}, and saving the calculation result into the storage medium; reading, by bijective calculation means, necessary data from the storage medium, calculating v=v′−n_{i_{m}} mod 2̂{κ}, and saving the calculation result into the storage medium; reading, by first conversion means, necessary data from the storage medium, calculating U=v̂{e_{i_{j}}} mod n_{i_{j}} if v<n_{i_{j}}, calculating U=v if v≧n_{i_{j}}, and saving the calculation result into the storage medium; repeating, by the second conversion means, the bijection calculation means, and the first conversion means, the steps each time the variable j is decremented by one until the variable j reaches 0; reading, by T_{j} calculation means, necessary data from the storage medium, calculating T_{j}=M_{—}{1}∥ . . . ∥M_{j}∥pk_{i_{—}{1}}∥ . . . ∥pk_{i_{j}}, and saving the calculation result into the storage medium; reading, by u calculation means, necessary data from the storage medium, calculating u_{i_{j−1}}=H(T_{j})◯U, and saving the calculation result into the storage medium; reading, by u checking means, necessary data from the storage medium and checking if u is a predetermined initial value; and outputting, by output means, a verification success notification if u is the predetermined initial value and, if not, outputting a verification failure notification.

A verification method according to claim 29 is a verification method comprising the steps of receiving, by input means, a signed text u_{i_{m−1}}, which is created by one or more other signature devices that sequentially perform a signature operation, auxiliary information v_{i_{m−1}} that is a signed text entered by an immediately preceding signature device or a hash value thereof, messages M_{—}{1}, . . . , M_{m−1} entered into the signature devices, and public keys pk_{i_{—}{1}}, . . . , pk_{i_{m−1}} of the signature devices and saving the signed text, the auxiliary information, the messages, and the public keys into a storage medium; reading, by T_{m−1} calculation means, necessary data from the storage medium, calculating T_{m−1}=M_{—}{1}∥ . . . ∥M_{m−1}∥pk_{i_{—}{1}}∥ . . . ∥pk_{i_{m−1}}, and saving the calculation result into the storage medium; reading, by v″ calculation means, necessary data from the storage medium, calculating v″=H(T_{m−1})◯u_{i_{m−1}}, and saving the calculation result into the storage medium; reading, by second conversion means, necessary data from the storage medium, calculating v′=v″̂{e_{i_{m−1}}} mod n_{i_{m−1}} if v″<n_{i_{m−1}}, calculating v′=v″ if V″≧n_{i_{m−1}}, and saving the calculation result into the storage medium; reading, by bijective calculation means, necessary data from the storage medium, calculating v=v′−n_{i_{m−1}} mod 2̂{κ}, and saving the calculation result into the storage medium; reading, by first conversion means, necessary data from the storage medium, calculating u_{i_{m−2}}=v̂{e_{i_{m−1}}} mod n_{i_{m−1}} if v<n_{i_{m−1}}, calculating u_{i_{m−2}}=v if v≧n_{i_{m−1}}, and saving the calculation result into the storage medium; reading, by u checking means, necessary data from the storage medium and checking if u_{i_{m−2}} or a hash value thereof matches the auxiliary information v_{i_{m−1}}; and outputting, by output means, a verification success notification if u_{i_{m−2}} or a hash value thereof matches the auxiliary information v_{i_{m−1}} and, if not, outputting a verification failure notification.

A signature device according to claim 30 a signature device comprising a readable/writable storage medium; input means that receives an initial value or a signed text u_{i_{m−1}}, which is created by other plurality of signature devices that sequentially perform a signature operation, and messages M_{—}{1}, . . . , M_{m−1} entered into the signature devices and saves the initial value or the signed text and the messages into the storage medium; T_{m} calculation means that reads necessary data from the storage medium and a public key storage device, calculates T_{m}=M_{—}{1}∥ . . . ∥M_{m}∥pk_{i_{—}{1}}∥ . . . ∥pk_{i_{m}} where pk_{i_{j}} is a public key of a signature device i_{j} and ∥ is a concatenation of bit strings, and saves the calculation result into the storage medium; exclusive OR calculation means that reads necessary data from the storage medium, calculates U=H(T_{m})◯u_{i_{i_{m−1}} where H is a hash function and ◯ is an exclusive OR, and saves the calculation result into the storage medium; first conversion means that reads necessary data from the storage medium, calculates v=û{d_{i_{m}}} mod n_{i_{m}} if U<n_{i_{m}} where n_{i_{m}} is an RSA modulus of the signature device, calculates v=U if U≧n_{i_{m}}, and saves the calculation result into the storage medium; bijective conversion means that reads necessary data from the storage medium, calculates v′=v+n_{i_{m}} mod 2̂{κ} where κ is a security parameter, and saves the calculation result into the storage medium; second conversion means that reads necessary data from the storage medium, calculates u_{i_{m}}=v′̂{d_{i_{m}}} mod n_{i_{m}} if v′<n_{i_{m}}, calculates u_{i_{m}}=v′ if v′≧n_{i_{m}}, and saves the calculation result into the storage medium; and output means that reads u_{i_{m}} from the storage medium and outputs u_{i_{m}} as the signed text.

A signature device according to claim 31 is the signature device as defined by claim 30, further comprising w setting means that calculates w_{i_{m}}=u_{i_{m−1}} or w_{i_{m}}=h(u_{i_{m−1}}) where h is a hash function and saves the calculation result into the storage medium, wherein the created signed text u_{i_{m}}, which is paired with the calculated w_{i_{m}, is output with w_{i_{m}} as auxiliary information.

A verification device according to claim 32 a verification device comprising a readable/writable storage medium; input means that reads a signed text u_{i_{m−1}}, which is created by one or more other signature devices that sequentially perform a signature operation, messages M_{—}{1}, . . . , M_{m−1} entered into the signature devices, and public keys pk_{i_{—}{1}}, . . . , pk_{i_{m−1}} and saves the signed text, the messages, and the public keys into the storage medium; j initialization means that sets m−1 in a variable j; second conversion means that reads necessary data from the storage medium, calculates v′=u_{i_{j}}̂{e_{i_{j}}} mod n_{i_{j}} if u_{i_{j}}<n_{i_{j}}, calculates v′=u_{i_{j} if u_{i_{j}}≧n_{i_{j}}, and saves the calculation result into the storage medium; bijective calculation means that reads necessary data from the storage medium, calculates v=v′−n_{i_{m}} mod 2̂{κ}, and saves the calculation result into the storage medium; first conversion means that reads necessary data from the storage medium, calculates U=v̂{e_{i_{j}}} mod n_{i_{j}} if v<n_{i_{j}}, calculates U=v if v≧n_{i_{j}}, and saves the calculation result into the storage medium; T_{j} calculation means that reads necessary data from the storage medium, calculates T_{j}=M_{—}{1}∥ . . . ∥M_{j}∥pk_{i_{—}{1}}∥ . . . ∥pk_{i_{j}}, and saves the calculation result into the storage medium after the second conversion means, the bijection calculation means, and the first conversion means repeat the steps each time the variable j is decremented by one until the variable j reaches 0; u calculation means that reads necessary data from the storage medium, calculates u_{i_{j−1}}=H(T_{j})◯U, and saves the calculation result into the storage medium; u checking means that reads necessary data from the storage medium and checks if u is a predetermined initial value; and output means that outputs a verification success notification if u is the predetermined initial value and, if not, outputs a verification failure notification.

A verification device according to claim 33 is a verification device comprising a readable/writable storage medium; input means that receives a signed text u_{i_{m−1}}, which is created by one or more other signature devices that sequentially perform a signature operation, auxiliary information v_{i_{m−1}} that is a signed text entered by an immediately preceding signature device or a hash value thereof, messages M_{—}{1}, . . . , M_{m−1} entered into the signature devices, and public keys pk_{i_{—}{1}}, . . . , pk_{i_{m−1}} of the signature devices and saves the signed text, the auxiliary information, the messages, and the public keys into the storage medium;

T_{m−1} calculation means that reads necessary data from the storage medium, calculates T_{m−1}=M_{—}{1}∥ . . . ∥M_{m−1}∥pk_{i_{—}{1}}∥ . . . ∥pk_{i_{m−1}}, and saves the calculation result into the storage medium; v″ calculation means that reads necessary data from the storage medium, calculates v″=H(T_{m−1})◯u_{i_{m−1}}, and saves the calculation result into the storage medium; second conversion means that reads necessary data from the storage medium, calculates v′=v″̂{e_{i_{m−1}}} mod n_{i_{m−1}} if v″<n_{i_{m−1}}, calculates v′=v″ if V″≧n_{i_{m−1}}, and saves the calculation result into the storage medium; bijective calculation means that reads necessary data from the storage medium, calculates v=v′−n_{i_{m−1}} mod 2̂{κ}, and saves the calculation result into the storage medium; first conversion means that reads necessary data from the storage medium, calculates u_{i_{m−2}}=v̂{e_{i_{m−1}}} mod n_{i_{m−1}} if v<n_{i_{m−1}}, calculates u_{i_{m−2}}=v if v≧n_{i_{m−1}}, and saves the calculation result into the storage medium; u checking means that reads necessary data from the storage medium and checks if u_{i_{m−2}} or a hash value thereof matches the auxiliary information v_{i_{m−1}}; and output means that outputs a verification success notification if u_{i_{m−2}} or a hash value thereof matches the auxiliary information v_{i_{m−1}} and, if not, outputs a verification failure notification.

A program according to claim 34 is a program that causes a computer having a readable/writable storage medium to function as input means that receives an initial value or a signed text u_{i_{m−1}}, which is created by other plurality of signature devices that sequentially perform a signature operation, and messages M_{—}{1}, . . . , M_{m−1} entered into the signature devices and saves the initial value or the signed text and the messages into the storage medium; T_{m} calculation means that reads necessary data from the storage medium and a public key storage device, calculates T_{m}=M_{—}{1}∥ . . . ∥M_{m}∥pk_{i_{—}{1}}∥ . . . . ∥pk_{i_{m}} where pk_{i_{j}} is a public key of a signature device i_{j} and ∥ is a concatenation of bit strings, and saves the calculation result into the storage medium; exclusive OR calculation means that reads necessary data from the storage medium, calculates U=H(T_{m})◯u_{i_{i_{m−1}} where H is a hash function and ◯ is an exclusive OR, and saves the calculation result into the storage medium; first conversion means that reads necessary data from the storage medium, calculates v=û{d_{i_{m}}} mod n_{i_{m}} if U<n_{i_{m}} where n_{i_m}} is an RSA modulus of the signature device, calculates v=U if U≧n_{i_{m}}, and saves the calculation result into the storage medium; bijective conversion means that reads necessary data from the storage medium, calculates v′=v+n_{i_{m}} mod 2̂{κ} where κ is a security parameter, and saves the calculation result into the storage medium; second conversion means that reads necessary data from the storage medium, calculates u_{i_{m}}=v̂{d_{i_{m}}} mod n_{i_{m}} if v′<n_{i_{m}}, calculates u_{i_{m}}=v′ if v′≧n_{i_{m}}, and saves the calculation result into the storage medium; and output means that reads u_{i_{m}} from the storage medium and outputs u_{i_{m}} as the signed text.

A program according to claim 35 is the program as defined by claim 34, further causing the computer to function as w setting means that calculates w_{i_{m}}=u_{i_{m−1}} or w_{i_{m}}=h(u_{i_{m−1}}) where h is a hash function and saves the calculation result into the storage medium, wherein the created signed text u_{i_{m}}, which is paired with the calculated w_{i_{m}, is output with w_{i_{mm}} as auxiliary information.

A program according to claim 36 is program that causes a computer having a readable/writable storage medium to function as input means that reads a signed text u_{i_{m−1}} which is created by one or more other signature devices that sequentially perform a signature operation, messages M_{—}{1}, . . . , M_{m−1} entered into the signature devices, and public keys pk_{i_{—}{1}}, . . . , pk_{i_{m−1}} and saves the signed text, the messages, and the public keys into the storage medium; j initialization means that sets m−1 in a variable j; second conversion means that reads necessary data from the storage medium, calculates v′=u_{i_{j}}̂{e_{i_{j}}} mod n_{i_{j}} if u_{i_{j}}<n_{i_{j}}, calculates v′=u_{i_{j} if u_{i_{j}}≧n_{i_{j}}, and saves the calculation result into the storage medium; bijective calculation means that reads necessary data from the storage medium, calculates v=v′−n_{i_{m}} mod 2̂{κ}, and saves the calculation result into the storage medium; first conversion means that reads necessary data from the storage medium, calculates U=v̂e_{i_{j}}} mod n_{i_{j}} if v<n_{i_{j}}, calculates U=v if v≧n_{i_{j}}, and saves the calculation result into the storage medium; T_{j} calculation means that reads necessary data from the storage medium, calculates T_{j}=M_{—}{1}∥ . . . ∥M_{j}∥pk_{i_μl}∥ . . . ∥pk_{i_{j}}, and saves the calculation result into the storage medium after the second conversion means, the bijection calculation means, and the first conversion means repeat the steps each time the variable j is decremented by one until the variable j reaches 0; u calculation means that reads necessary data from the storage medium, calculates u_{i_{j−1}}=H(T_{j})◯U, and saves the calculation result into the storage medium; u checking means that reads necessary data from the storage medium and checks if u is a predetermined initial value; and output means that outputs a verification success notification if u is the predetermined initial value and, if not, outputs a verification failure notification.

A program according to claim 37 is a program that causes a computer having a readable/writable storage medium to function as input means that receives a signed text u_{i_{m−1}}, which is created by one or more other signature devices that sequentially perform a signature operation, auxiliary information v_{i_{m−1}} that is a signed text entered by an immediately preceding signature device or a hash value thereof, messages M_{—}{1}, . . . , M_{m−1} entered into the signature devices, and public keys pk_{i_{—}{1}}, . . . , pk_{i_{m−1}} of the signature devices and saves the signed text, the auxiliary information, the messages, and the public keys into the storage medium; T_{m−1} calculation means that reads necessary data from the storage medium, calculates T_{m−1}=M_{—}{1}∥ . . . ∥M_{m−1}∥pk_{i_{—}{1}}∥ . . . ∥pk_{i_{m−1}}, and saves the calculation result into the storage medium; v″ calculation means that reads necessary data from the storage medium, calculates v″=H(T_{m−1})◯u_{i_{m−1}}, and saves the calculation result into the storage medium; second conversion means that reads necessary data from the storage medium, calculates v′=v″̂{e_{i_{m−1}}} mod n_{i_{m−1}} if v″<n_{i_{m−1}}, calculates v′=v″ if V″≧n_{i_{m−1}}, and saves the calculation result into the storage medium; bijective calculation means that reads necessary data from the storage medium, calculates v=v′−n_{i_{m−1}} mod 2̂{κ}, and saves the calculation result into the storage medium; first conversion means that reads necessary data from the storage medium, calculates u_{i_{m−2}}=v̂{e_{i_{m−1}}} mod n_{i_{m−1}} if v<n_{i_{m−1}}, calculates u_{i_{m−2}}=v if v≧n_{i_{m−1}}, and saves the calculation result into the storage medium; u checking means that reads necessary data from the storage medium and checks if u_{i_{m−2}} or a hash value thereof matches the auxiliary information v_{i_{m−1}}; and output means that outputs a verification success notification if u_{i_{m−2}} or a hash value thereof matches the auxiliary information v_{i_{m−1}} and, if not, outputs a verification failure-notification.

### [Operation]

According to the present invention, the signature device i_{m} performs a first operation in which the device performs no operation if a received signed text u_{i_{m−1}} exceeds the modulus n_{i_{m}} but, if not, adds an RSA-signature-based signature, a second operation in which the device multiplies the result of the first operation by a function that maps the result to a value larger by the modulus n_{i_{m}}, and a third operation in which the device performs no operation if the result of the second operation exceeds the modulus n_{i_{m}} but, if not, adds an RSA-signature-based signature. At this time, if the number of bits of the RSA modulus of each signature device is equal to the security parameter κ, the modulus n_{i_{m}} of the signed text u_{i_{m−1}} and the signature device i_{m} becomes a number smaller than 2̂{κ}. In the first operation, because an RSA-signature-based signature is added to the signed text u_{i_{m−1}} whose value is 0 to n_{i_{m}}, the value after the first operation is 0 to n_{i_{m}} On the other hand, because no operation is performed for the signed text u_{i_{m−1}} whose value is n_{i_{m}} to 2̂{κ}, the value after the first operation is n_{i_{m}} to 2̂{κ}. In the second operation, because n_{i_{m}} is added to the value after the first operation with 2̂{κ} as the modulus, the value after the second operation also becomes a number smaller than 2̂{κ} but, if the value after the first operation is n_{i_{m}} to 2̂{κ}, the value after the second operation is 0 to n_{i_{m}}. Therefore, by adding an RSA-signature-based signature to a value after the second operation that is 0 to n_{i_{m}}, at least one RSA signature is added to the signed text u_{i_{m−1}} of any value. In addition, there is a one-to-one correspondence between the value after the third operation, that is, the signature value u_{i_m}}, and the received signed text u_{i_{m−1}}, the performed signature operation can be determined uniquely by the value of the signature value u_{i_{m}} and, therefore, there is no need to add control bits as in Non-Patent Document 1.

### MERITORIOUS EFFECTS OF THE INVENTION

The first effect is that the signature length does not depend on the number of signature devices. The reason is that the number of bits of the data before the signature is equal to the number of bits of the data after the signature.

The second effect is that the sequence of signature devices may be changed each time the signature is created. The reason is the same as that of the first effect, that is, the number of bits of the data before the signature is equal to the number of bits of the data after the signature. Therefore, the input to each signature device is fixed regardless of the sequence in which the signature device adds its signature, thus making it possible for the signature device to add the signature by performing the same operation regardless of the sequence.

The third effect is that an attacker, who makes bad use of a signature device, cannot forge a signed text that has passed through honest signature devices along the path. The reason is that, whatever u is input to a signature device, u is changed by at least one of two RSA calculations that are performed up to two times at the signature time.

The fourth effect is that there is no need to know the number (m) of signature devices when the system operation is started but that the operation can be performed without any problem even if the number (m) of signature devices is dynamically changed during the operation. The reason is that the signature procedure for m+1 signature devices is that another signature operation is performed in the same way after the signature procedure for m signature devices is performed, meaning that the signature operation method does not depend on the number m of signature devices.

### BRIEF DESCRIPTION OF THE DRAWINGS

FIG. 1 is a block diagram of a first embodiment of the present invention.

FIG. 2 is a block diagram showing the configuration of a signature device in the first embodiment of the present invention.

FIG. 3 is a flowchart showing the operation of the signature device in the first embodiment of the present invention.

FIG. 4 is a block diagram showing the configuration of a verification device in the first embodiment of the present invention.

FIG. 5 is a flowchart showing the operation of the verification device in the first embodiment of the present invention.

FIG. 6 is a block diagram of a second embodiment of the present invention.

FIG. 7 is a block diagram showing the configuration of a signature device in the second embodiment of the present invention.

FIG. 8 is a flowchart showing the operation of the signature device in the second embodiment of the present invention.

FIG. 9 is a block diagram showing the configuration of a verification device in the second embodiment of the present invention.

FIG. 10 is a flowchart showing the operation of the verification device in the second embodiment of the present invention.

FIG. 11 is a flowchart showing the operation of a conventional signature device.

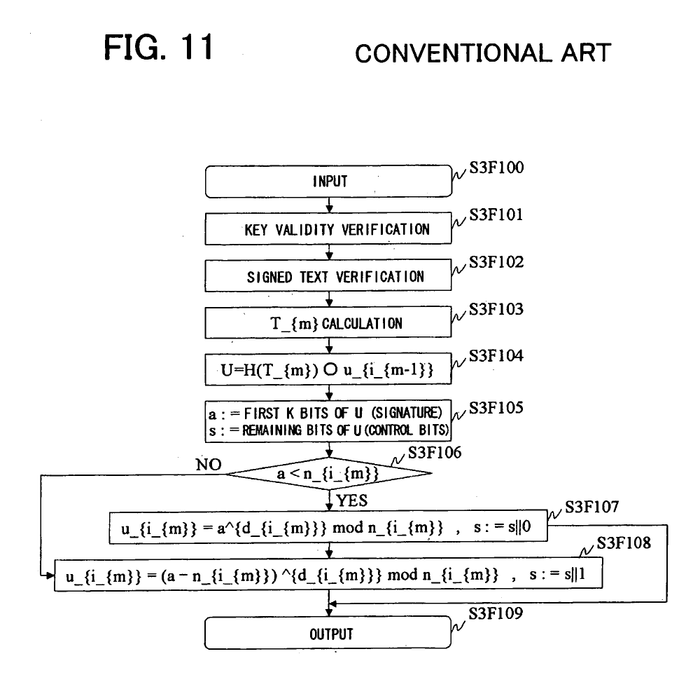

### EXPLANATIONS OF SYMBOLS

i_{—}{1}, . . . , i_{m−1} Signature device
i_{—}{1}−2, . . . , i_{m−1}−2 Verification device
i_{—}{1}−3, . . . , i_{m−1}−3 Key storage device
i_{—}{1}−4, . . . , i_{m−1}−4 Key validity verification device
i_{—}{1}−5, . . . , i_{m−1}−5 Key generation device
M_{—}{1}, . . . , M_{m} Message
u_{i_{—}{0}, . . . , u_{i_{m−1}} Signed text
w_{i_{—}{0}}, . . . , w_i_{m−1}} Auxiliary information

### MOST PREFERRED MODE FOR CARRYING OUT THE INVENTION

### First Embodiment

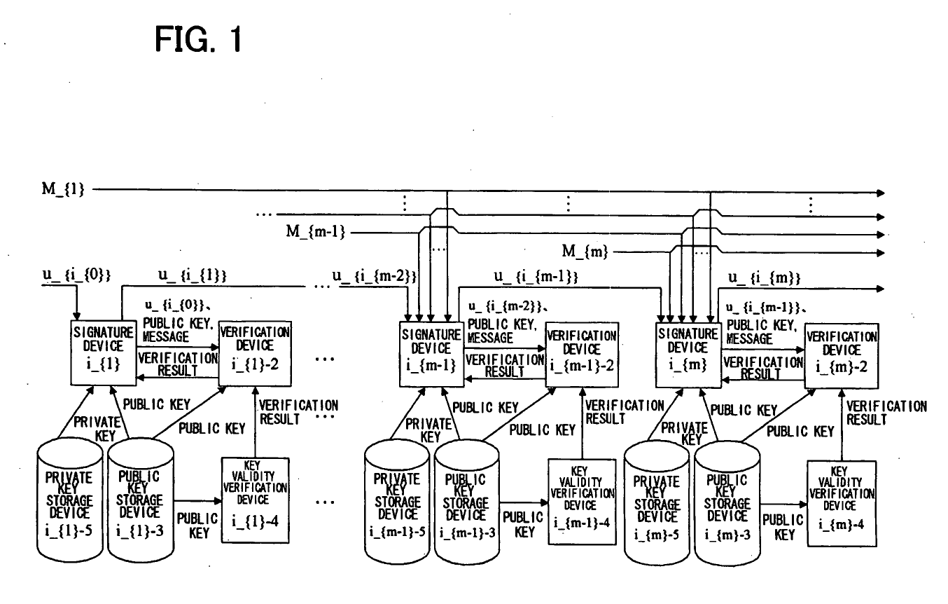

Referring to FIG. 1, a first embodiment of the present invention comprises signature devices i_{—}{1}, . . . , i_{m}, verification devices i_{—}{1}−2, . . . , i_{m}−2, public key storage devices i_{—}{1}−3, . . . , i_{m}−3, key validity verification devices i_{—}{1}−4, . . . , i_{m}−4, and private key storage devices i_{—}{1}−5, . . . , i_{m}−5.

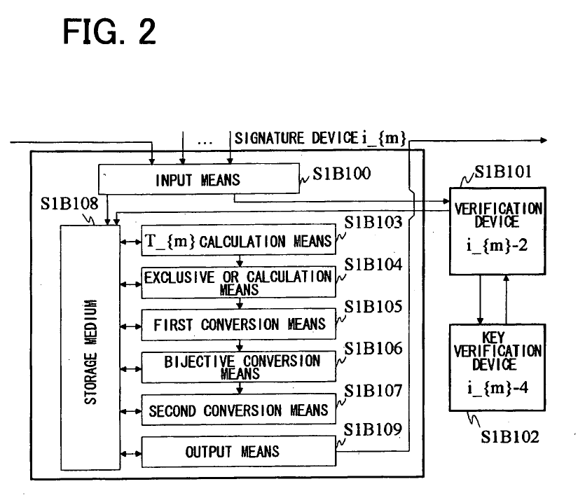

Referring to FIG. 2, the signature device i_{m} comprises input means S1B100, T_{m} calculation means S1B103, exclusive OR calculation means S1B104, first conversion means S1B105, bijective conversion means S1B106, second conversion means S1B107, a storage medium S1B108, and output means S1B109. Other signature devices have the same configuration as the signature device i_{m}.

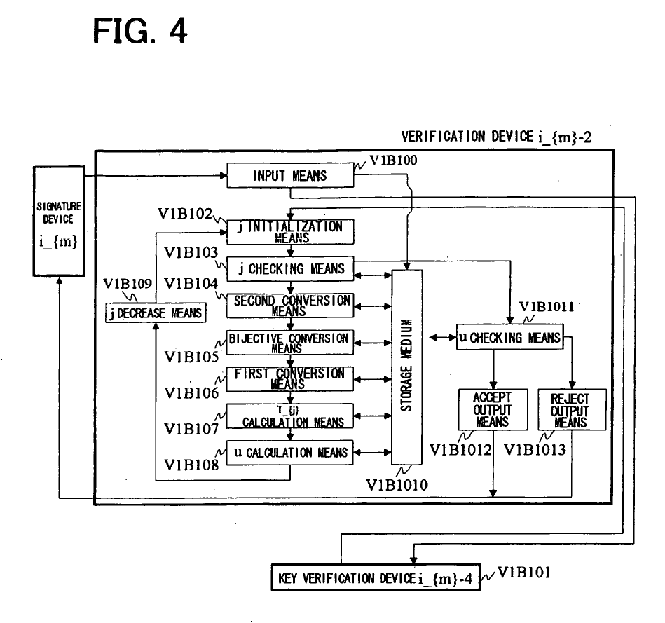

Referring to FIG. 4, the verification device i_{m}−2 comprises input means V1B100, j initialization means V1B102, j checking means V1B103, second conversion means V1B104, bijective conversion means V1B105, first conversion means V1B106, T_{j} calculation means V1B107, u calculation means V1B108, j decrease means V1B109, a storage medium V1B1010, u checking means V1B1011, accept output means V1B1012, and reject output means V1B1013. Other verification devices have the same configuration as the verification device i_{m}−2.

The following describes the overview of this embodiment. First, the public key/private key pair of the signature device i_{—}{1}, an initial value u_{i_{—}{0}}, and a message M_{—}{1} are entered into the signature device i_{—}{1}. The signature device i_{—}{1} uses u_{i_{—}{0}} to create a signed text u_{i_{—}{1}} for the message M_{—}{1}. In the same manner, the public key/private key pair of the signature device i_{j}, signed text u_{i_{j−1}} output by the immediately preceding signature device, and a message M_{j} are entered sequentially into the signature device i_{j}, and the signature device i_{j} uses them to create a signed text u_{i_{j}}. The signed text u_{i_{j}} is data representing that the signature device i_{—}{1} signs the message M_{—}{1}, the signature device i_{—}{2} signs the message M_{—}{2}, . . . , and the signature device i_{j} signs the message M_{j}.

For each j, the public keys and the messages M_{—}{1}, . . . , M_{j−1} of the signature devices i_{—}{1}, . . . , i_{j} and the signed text u_i_{j−1} are entered into the verification device i_{j}. Then, the verification device i_{j} verifies whether or not the signed text u_{i_{j−1}} is a signed text created for the messages M_{—}{1}, . . . , M_{j−1} using the private keys of the signature devices i_{—}{1}, . . . , i_{j−1}.

The goal of the system in this embodiment is to create a signed text u_{i_{m}}, that is, data representing that the signature device i_{—}{1} signs the message M_{—}{1}, the signature device i_{—}{2} signs the message M_{—}{2}, . . . , and the signature device i_{m} signs the message M_{m}.

Note that there is no need to know the number of signature devices, m, when the operation of the system in this embodiment is started. The number of signature devices, m, may be dynamically changed during the operation. The signature devices i_{—}{1}, . . . , i_{m} perform the same operation. The verification devices, the public key storage devices, the key validity verification devices, and the private key storage devices also perform basically the same operation.

Next, the following describes this embodiment more in detail.

The public key pk_{i} and the private key sk_{i} of the signature device i_{j} are (n_{i}, e_{i}) and (p_{i_{j}} q_{i_{j}}, d_{i_{j}}) respectively and satisfy the following five properties.

1. p_{i_{j}} and q_{i_{j}} are prime numbers.
2. n_{i_{j}}=p_{i_{j}}q_{i_{j}}
3. The number of bits of n_{i_{j}} is equal to the security parameter κ.
4. The number of bits of p_{i_{j}} is almost equal to the number of bits of q_{i_{j}}.
5. e_{i_{j}} and Φ(n_{i}) are relatively prime.
6. d_{i_{j}}=e_{i_{j}}−1 mod Φ(n_{i})
where Φ(n_{i}) is the number of relatively prime integers that are one or larger and smaller than n_{i} and that are relatively prime to n_{i}. The method for creating (pk_{i} and (sk_{i}) that satisfy those properties is described, for example, in Non-Patent Document 2 “Alfred J. Menezes Paul C. van Oorschot, and Scott A. Vanstone. Handbook of Applied Cryptography. CRC Press.” (http://www.cacr.math.uwaterloo.ca/hac/).

From the viewpoint of safety, it is desirable that everyone can confirm that e_{i_{j}} and Φ(n_{i}) are relatively prime. One of the methods for making this confirmation possible is to set e_{i_{j}} to a prime number larger than n_{i}. However, e_{i_{j}} need not always satisfy this property.

For each of j=1, . . . , m, the private key storage device i_{j}−5 stores the private key sk_{i_{j}}, and the public key storage device i_{j}−3 stores the public keys pk_{—}{1}, . . . , pk_{m}.

The following describes the operation of the key validity verification device i_{m}−4. The key validity verification device i_{m}−4 is a device that verifies the validity of the public keys pk_{i_{—}{1}}, . . . , pk_{i_{m−1}}. To confirm the validity, the key validity verification device first reads pk_{i_{—}{1}}, . . . , pk_{i_{m−1}} from the key storage device i_{m}−3 and confirms that pk_{i_}, . . . , pk_{i_{m−1}} are different to each other. When m=1, the key validity verification device does not perform any confirmation operation.

From the viewpoint of safety, although it is desirable to confirm that e_{i_{j}} and Φ(n_{i}) are relatively prime, it is also possible to omit this confirmation.

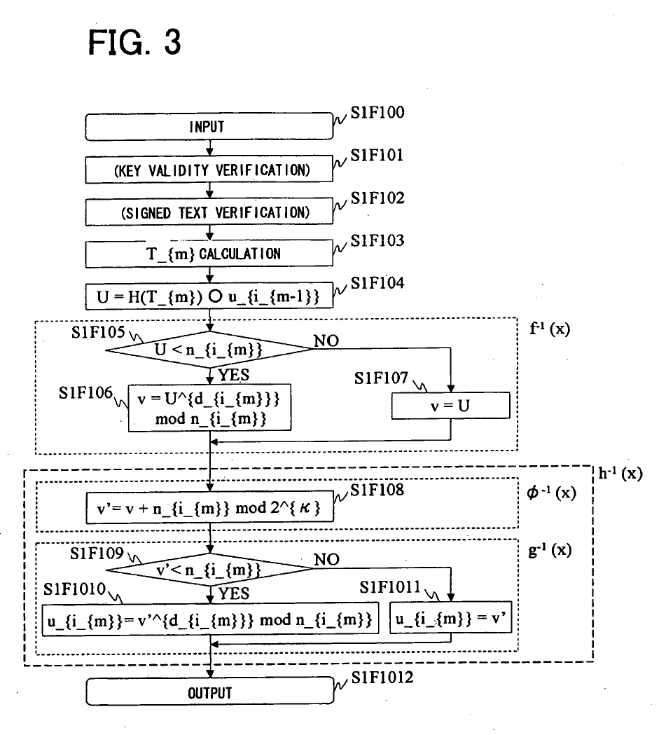

The following describes the operation of the signature device i_{m}. With reference to FIG. 2 and FIG. 3, the following describes how the signature device i_{m} signs the message M_{m} when the messages M_{—}{1}, . . . , M_{m} and the signed text u_{i_{m−1}} for the messages M_{—}{1}, . . . , M_{m−1}, created by the signature devices i_{—}{1}, . . . , i_{m−1} using the public keys pk_{i_{—}{1}}, . . . ; pk_{i_{m−1}}, are entered.

First, via the input means S1B101, the signature device i_{m} reads M_{—}{1}, . . . , M_{m}, pk_{i_{—}{1}}, . . . , pk_{i_{m}}, sk_{i_{m}}, and u_{i_{m−1}} and stores them in the storage medium S1B101 (S1F100). Note that, when m=1, u_{i_{—}{0}}=0 is assumed.

Next, the signature device i_{m} sends u_{i_{m−1}}, M_{—}{1}, . . . , M_{m−1}, and pk_{i_{—}{1}}, . . . , pk_{i_{m−1}} to the verification device i_{m−2}. The verification device i_{m}−2 verifies the validity of the signed text u_{i_{m−1}} (S1B101, S1F102). At this time, the verification device i_{m}−2 sends pk_{i_{—}{1}}, . . . , pk_{i_{m−1}} to the key validity verification device i_{m}−4. The key validity verification device i_{m}−4 verifies the validity of the keys (S1B102, S1F101). Note that, when m=1, the key validity verification device i_{m}−4 only confirms that u_{i_{—}{0}}=0.

Although it is desirable to perform the verification of u_{i_{m−1}} and the verification of key validity described above from the viewpoint of safety, one of the operations or both operations may be omitted to increase efficiency.

Next, via the T_{m} calculation means S1B103, the signature device i_{m} reads necessary data from the storage medium S1B108 and calculates T_{m}=M_{—}{1}∥ . . . ∥M_{m}∥pk_{i_{—}{1}}∥ . . . ∥pk_{i_{m}} (S1F103). After the calculation, the T_{m} calculation means S1B103 writes the calculation result into the storage medium S1B108.

Next, via the exclusive OR means S1B104, the signature device i_{m} reads necessary data from the storage medium S1B108, calculates U=H(T_{m})◯u_{i_{m−1}}, and writes the calculation result into the storage medium S1B108 (S1F104). H is the hash function that outputs the hash value of the same number of bits as that of the input.

Next, via the first conversion means S1B105, the signature device i_{m} reads data, entered into the signature device i_{m}, from the storage medium S1B108 and first checks if U is smaller than n_{i_{m}} (S1F105). If U<n_{i_{m}}, the signature device i_{m} calculates v=û{d_{i_m}}} mod n_{i_{m}} via the first conversion means S1B105, and writes the calculation result into the storage medium S1B108 (S1F106). Conversely, if U≧n_{i_{m}}, the signature device i_{m} performs the calculation v=u via the first conversion means S1B105 and writes the calculation result into the storage medium S1B108 (S1F107).

Next, via the bijective conversion means S1B106, the signature device i_{m} reads necessary data from the storage medium S1B108, calculates v′=v+n_{i_{m}} mod 2̂{κ}, and writes the calculation result into the storage medium S1B108 (S1F108).

Next, via the second conversion means S1B107, the signature device i_{m} reads necessary data from the storage medium S1B108 and checks if v′ is smaller than n_{i_{m}} (S1F109). If v′<n_{i_{m}}, the signature device i_{m} calculates u_{i_{m}}=v′̂{d_{i_{m}}} mod n_{i_{m}} and writes the calculation result into the storage medium S1B108 (S1F1010). Conversely, if v′≧n_{i_{m}}, the signature device i_{m} calculates u_{i_{m}}=v′ via the second conversion means S1B107 and writes the calculation result into the storage medium S1B108 (S1F1011).

Finally, via the output means S1B109, the signature device i_{m} reads u_{i_{m}} from the storage medium S1B108 and outputs it (S1F1012).

As described above, the signature device i_{m} checks if the received signed text u_{i_{m−1}} exceeds the modulus n_{i_{m}}. The signature device i_{m} performs no operation if the received signed text u_{i_{m−1}} exceeds the modulus n_{i_{m}} but performs the first operation, in which an RSA-based signature is added, if the received signed text u_{i_{m−1}} does not exceed the modulus n_{i_{m}}. The signature device i_{m} performs the second operation, in which the result of the first operation is multiplied by the function that maps the result to a value larger by modulus n_{i_{m}}. The signature device i_{m} checks if the result of the second operation exceeds modulus n_{i_{m}}, and performs no operation if the result exceeds the modulus n_{i_{m}} but performs the RSA-based third operation to add the signature if the result does not exceed the modulus n_{i_{m}}. Although the RSA signature operation is redundantly performed twice depending upon the value of the signed text u_{i_{m−1}}, the signature operation that is performed can be uniquely determined by the value of the signature value u_{i_{m}} and, therefore, there is no need to add control bits as in the method described in Non-Patent Document 1.

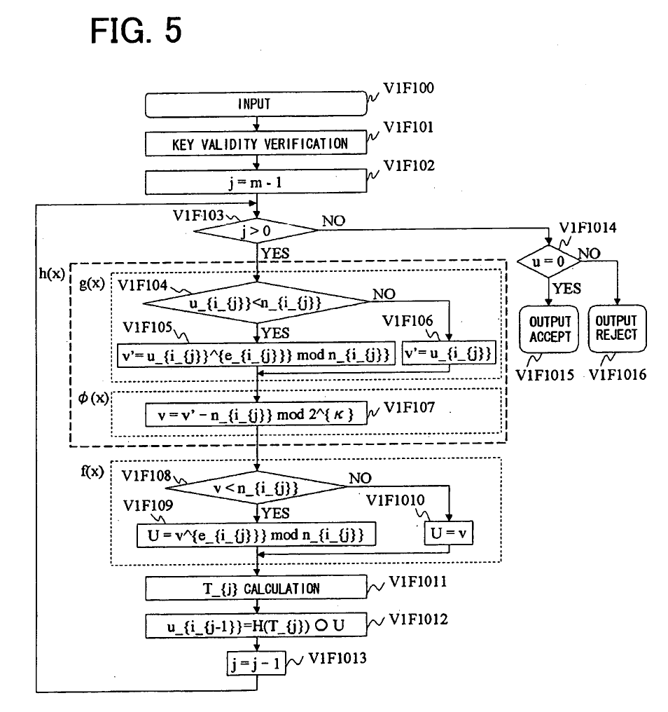

Next, with reference to FIG. 4 and FIG. 5, the following describes how the verification device i_{m}−2 verifies the signed text u_{m−1}.

First, via the input means V1B100, the verification device i_{m}−2 reads pk_{i_{—}{1}}, . . . , pk_{i_{m−1}} from the public key storage device i_{m}−3 and, in addition, reads messages M_{—}{1}, . . . , M_{m−1} (V1F100). The data that is read is written into the storage medium V1B1010 by the input means V1B100.

Next, the verification device i_{m}−2 sends the pk_{i_{—}{1}}, . . . , pk_{i_{m−1}} to the key verification device i_{m}−4 via the input means V1B100 to request it to verify the validity of the public keys pk_{i_{—}{1}}, . . . , pk_{i_{m−1}} (V1B101, V1F101).

Next, to sequentially verify the signature devices in reverse order from the immediately-preceding signature device to the first signature device, the verification device i_{m}−2 sets m−1 in the variable j, which manages which message in which signature device is being verified, via the j initialization means V1B102 (V1F102).

Next, the verification device i_{m}−2 checks if j>0 via the j checking means V1B103 (V1F103).

The following describes the operation of the verification device i_{m}−2 when j>0. The operation performed when j>0 is not satisfied will be described later.

Next, via the second conversion means V1B104, the verification device i_{m}−2 first reads necessary data from the storage medium V1B1010 and checks if u_{i_{j}}<n_{i_{j}} (V1F104).

If u_{i_{j}}<n_{i_{j}}, the verification device i_{m}−2 calculates v′=u_{i_{j}}̂{e_{i_{j}}} mod n_{i_{j}} and writes the calculation result into the storage medium V1B1010 (V1F105) via the second conversion means V1B104.

Conversely, if u_{i_{j}}<n_{i_{j}} is, not satisfied, the verification device i_{m}−2 sets v′=u_{i_{j} and writes the calculation result into the storage medium V1B1010 via the second conversion means V1B104 (V1F106).

Next, via the bijective calculation means V1B105, the verification device i_{m}−2 reads necessary data from the storage medium V1B1010, calculates v=v′−n_{i_{m}} mod 2̂{κ}, and writes the calculation result into storage medium V1B1010 (V1F107).

Next, via the first conversion means V1B106, the verification device i_{m}−2 reads necessary data from the storage medium V1B1010 and first checks if v<n_{i_{j}} (V1F108).

If v<n_{i_{j}}, the verification device i_{m}−2 calculates U=v̂{e_{i_{j}}} mod n_{i_{j}} and writes the calculation result into the storage medium V1B1010 via the first conversion means V1B106 (V1F109).

On the other hand, if v<n_{i_{j}} is not satisfied, the verification device i_{m}−2 performs the calculation U=v and writes the calculation result into the storage medium V1B1010 via the first conversion means V1B106 (V1F1010).

Next, via the T_{j} calculation means V1B107, the verification device i_{m}−2 reads necessary data from the storage medium V1B1010, calculates T_{j}=M_{—}{1}∥ . . . ∥M_{j}∥pk_{i_{—}{1}}∥ . . . ∥pk_{i_{j}}, and writes the calculation result into the storage medium V1B1010 (V1F1011).

Next, via the u calculation means V1B108, the verification device i_{m}−2 reads necessary data from the storage medium V1B1010, calculates u_{i_{j−1}}=H(T_{j})◯U, and writes the calculation result into the storage medium V1B1010 (V1F1012).

Next, the verification device i_{m}−2 sets j=j−1 via the j decrease means V1B109 (V1F1013).

The verification device i_{m}−2 checks if j>0 again via the j checking means V1B103 (V1F103).

If j>0, the verification device i_{m}−2 performs the processing in step V1F104 and the following steps.

If j=0, the verification device i_{m}−2 reads necessary data from the storage medium V1B1010 and checks if u=0 via the u checking means V1B1011 (V1F1014).

If u=0, the verification device i_{m}−2 outputs accept, which indicates successful verification, via the accept output means V1B1012 (V1F1015); otherwise, the verification device i_{m}−2 outputs reject, which indicates unsuccessful verification, via the reject output means V1B1013 (V1F1016).

Now, let f(x), g(x), and φ(x) be the operations enclosed by the dotted line in FIG. 5.

### That is,

f(x)=x̂{e_{—}{i_{—}{j}}} mod n_{—}{i_{—}{j}} if x<n_{—}{i_{—}{j}}=x otherwise.

g(x)=x̂{e_{—}{i_{—}{j}}} mod n_{—}{i_{—}{j}} if x<n_{—}{i_{—}{j}}=x otherwise.

φ(x)=x+n_{—}{i_{—}{j}} mod 2̂{κ}

h(x)=g(φ(x))

Then, the operations f̂{−1}(x), ĝ{−1}(x), ĥ{−1}(x), and φ̂{−1}(x) in the part enclosed by the dotted line in FIG. 3 are the inverse functions of f(x), g(x), h(x), and φ(x), respectively.

Therefore, the signature device i_{m} in this embodiment creates a signed text using the calculation expression u_{i_{m}}=(g_{m}̂{−1}(φ̂{−1}(f_{m}̂{−1}(H(T_{m})◯u_{i_{m−1}})))). The verification device i_{m}−2 in this embodiment finds the signed text that is entered into the immediately preceding signature device using u_{i_{m−2}}=H(T_{m−1})◯(f_{m−1}(φ(g_{m−1}(u_{i_{m−1}})))), finds the initial value of the input by repeating the same processing until the first signature device is reached, and checks if the initial value that is found matches the predetermined initial value (value of 0 in this embodiment).

Next, the following describes the effect of this embodiment.

The first effect is that the signature length does not depend on the number of signature devices. The reason is that the number of bits of the data before the signature is equal to the number of bits of the data after the signature.

The second effect is that the sequence of signature devices may be changed each time the signature is created. The reason is the same as that of the first effect, that is, the number of bits of the data before the signature is equal to the number of bits of the data after the signature. Therefore, the input to each signature device is fixed regardless of the sequence in which the signature device adds its signature, thus making it possible for the signature device to add the signature by performing the same operation regardless of the sequence. However, it is necessary to notify the verification device about the sequence in which the signature is added.

The third effect is that an attacker, who makes bad use of a signature device, cannot forge a signed text that has passed through honest signature devices along the path. The reason is that, whatever u is input to a signature device, u is changed by at least one of two RSA calculations that are performed at the signature time.

The fourth effect is that there is no need to know the number (m) of signature devices when the system operation is started but that the operation can be performed without any problem even if the number (m) of signature devices is dynamically changed during the operation. The reason is that the signature procedure for m+1 signature devices is that another signature operation is performed in the same way after the signature procedure for m signature devices is performed, meaning that the signature operation method does not depend on the number m of signature devices.

In the first embodiment described above, the RSA function, which is the most typical function, is used in the description. More generally, a signature method in which the signature length does not depend on the number of signers and which ensures safety can be implemented in the same way as in the first embodiment if there is a subset X having {0,1}̂{κ} and if the conditions (1) and (2) described below are satisfied.

(1) f and g are trapdoor one-way replacements, and X is included in both the domain of f and the domain of g.
(2) φ is a bijection on {0,1}̂{κ} where both φ and φ̂{−1} can be calculated in polynomial time, and {0,1}̂{κ}\X is mapped to X.
The trapdoor one-way replacement is a function that satisfies the following four properties:
1) Is easy to calculate f.
2) Is difficult for a person, who does not know the trapdoor (also called a private key), to calculate f̂{−1}.
3) Is easy for a person, who knows the trapdoor, to calculate f̂{−1}.
4) Is a bijection.

In addition, if there is a subset X having {0,1}̂{κ} and if the conditions (1) and (2) described below are satisfied, a signature method in which the signature length does not depend on the number of signers and which ensures safety can be implemented in the same way as in the first embodiment.

(1) f is a trapdoor one-way replacement, and X is included in the domain of f.
(2) h is a trapdoor one-way replacement, and {0,1}̂{κ}\X is included in the domain of h.

### Second Embodiment

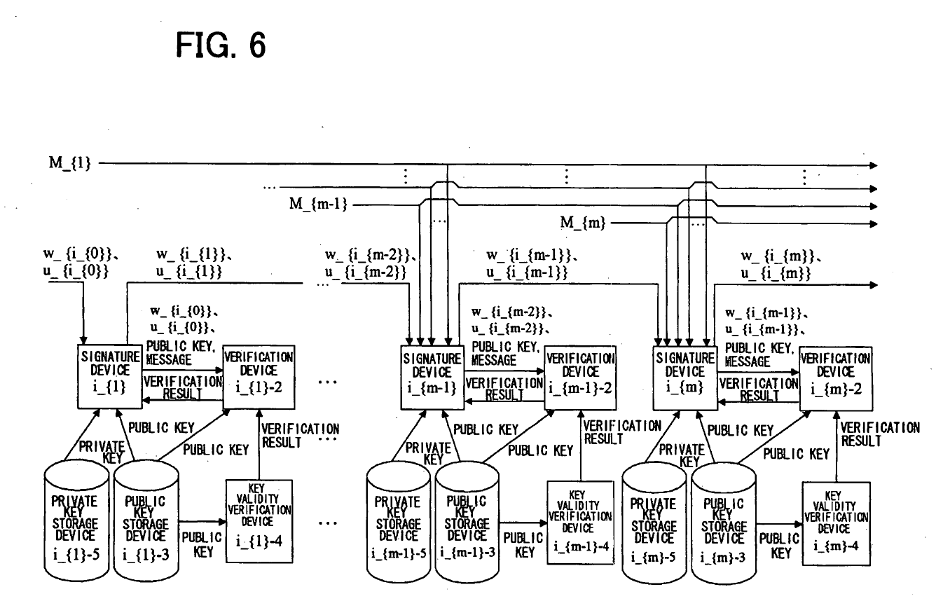

Referring to FIG. 6, a second embodiment of the present invention comprises signature devices i_{—}{1}, . . . , i_{m}, verification devices i_{—{}1}−2, . . . , i_{m}−2, public key storage devices i_{—}{1}−3, . . . , i_{m}−3, key validity verification devices i_{—}{1}−4, . . . , i_{m}−4, and private key storage devices i_{—}{1}−5, . . . , i_{m}−5.

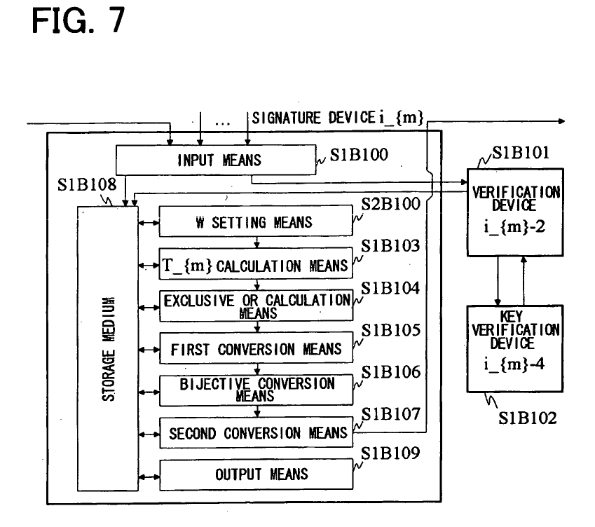

Referring to FIG. 7, the signature device i_{m} comprises input means S1B100, T_{m} calculation means S1B103, exclusive OR calculation means S1B104, first conversion means S1B105, bijective conversion means S1B106, second conversion means S1B107, a storage medium S1B108, output means S1B109, and w setting means S2B100. Other signature devices have the same configuration as the signature device i_{m}.

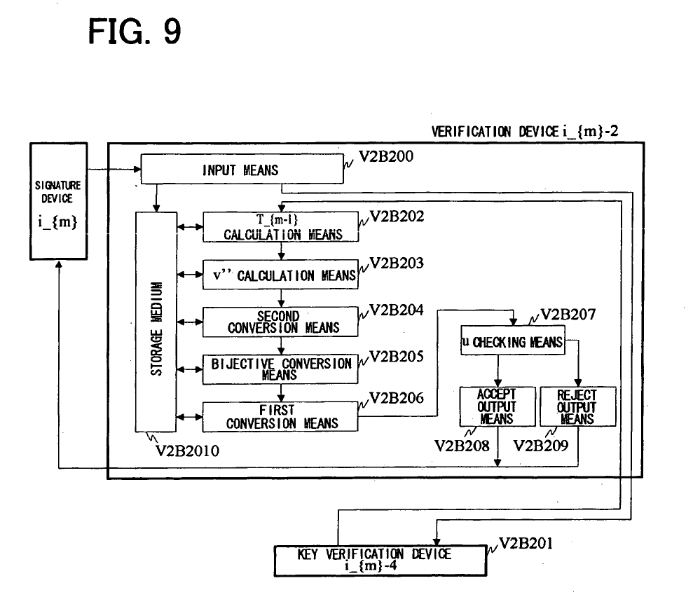

Referring to FIG. 9, the verification device i_{m}−2 comprises input means V2B200, T_{m−1} calculation means V2B202, v″ calculation means V2B203, second conversion means V2B204, bijective conversion means V2B205, first conversion means V2B206, u checking means V2B207, accept output means V2B208, reject output means V2B209, and a storage medium V2B2010. Other verification devices have the same configuration as the verification device i_{m}−2.

The following describes the overview of this embodiment. First, the public key/private key pair of the signature device i_{—}{1}, an initial value u_{i_{—}{0}}, and a message M_{—}{1} are entered into the signature device i_{—}{1}. The signature device i_{—}{1} uses u_{i_{—}{0}} to create a signed text u_{i_{—}{1}} for the message M_{—}{1}, creates the initial value u_{i_{—}{0}} as auxiliary information w_{i_{—}{1}}, and outputs the pair of u_{i_{—}{1}} and w_{i_{—}{1}}. Next, the public key/private key pair of the signature device i_{—}{2}, the pair of u_{i_{—}{1}} and w_{i_{—}{1}}, and a message M_{—}{2} are entered into the signature device i_{—}{2}. The signature device i_{—}{2} uses u_{i_{—}{1}} to create a signed text u_{i_{—}{2}} for the message M_{—}{2}, creates u_{i_{—}{1}} as auxiliary information w_{i_{—}{2}}, and outputs the pair of u_{i_{—}{2}} and w_{i_{—}{2}}. In the same manner, the public key/private key pair of the signature device i_{j}, the signed text u_{i_{j−1}} and the auxiliary information w_{i_{j−1}} that are output by the immediately preceding signature device, and a message M_{j} are entered sequentially into the signature device i_{j}, and the signature device i_{j} uses them to create the pair of a signed text u_{i_{j}} and auxiliary information w_{i_{j}}. u_{i_{j}}, which is the same signed text as that in the first embodiment, is data representing that the signature device i_{—}{1} signs the message M_{—}{1}, the signature device i_{—}{2} signs the message M_{—}{2}, . . . , and the signature device i_{j} signs the message M_{j}.

w_{i_{j}} is auxiliary information that makes the verification of signed text u_{i_{j}} easy and, in this embodiment, the auxiliary information is the signed text u_{i_{j−1}} that is the input to the signature device i_{j}. For each j, when the public keys of the signature devices i_{—}{1}, . . . , i_{j}, the messages M_{—}{1}, . . . , M_{j−1}, and u_{i_{j−1}} and w_{i_{j−1}} are entered into the verification device i_{j}, the verification device i_{j} verifies if u_{i_{j−1}} is a signed text, created for the messages M_{—}{1}, . . . , M_{j−1} using the public keys of the signature devices i_{—}{1}, . . . , i_{j−1}, based on the auxiliary information w_{i_{j−1}}.

As in the first embodiment, the goal of the system in this embodiment is to create a signed text u_{i_{m}}, that is, data representing that the signature device i_{—}{1} signs the message M_{—}{1}, the signature device i_{—}{2} signs the message M_{—}{2}, . . . and the signature device i_{m} signs the message M_{m}.

Note that, as in the first embodiment, there is no need to know the number of signature devices, m, when the operation of the system in this embodiment is started. The number of signature devices, m, may be dynamically changed during the operation. The signature devices i_{—}{1}, . . . , i_{m} perform the same operation. The verification devices, the public key storage devices, the key validity verification devices, and the private key storage devices also perform basically the same operation.

Next, the following describes the detail of this embodiment with focus on the difference from the first embodiment.

The public key pk_{i} and the private key sk_{i} of the signature device i_{j} are created in the same way as in the first embodiment. For each of j=1, . . . , m, the private key storage device i_{j}−5 stores the private key sk_{i_{j}}, and the public key storage device i_{j}−3 stores the public keys pk_{—}{1}, . . . , pk_{m}.

The key validity verification device performs the same operation as in the first embodiment.

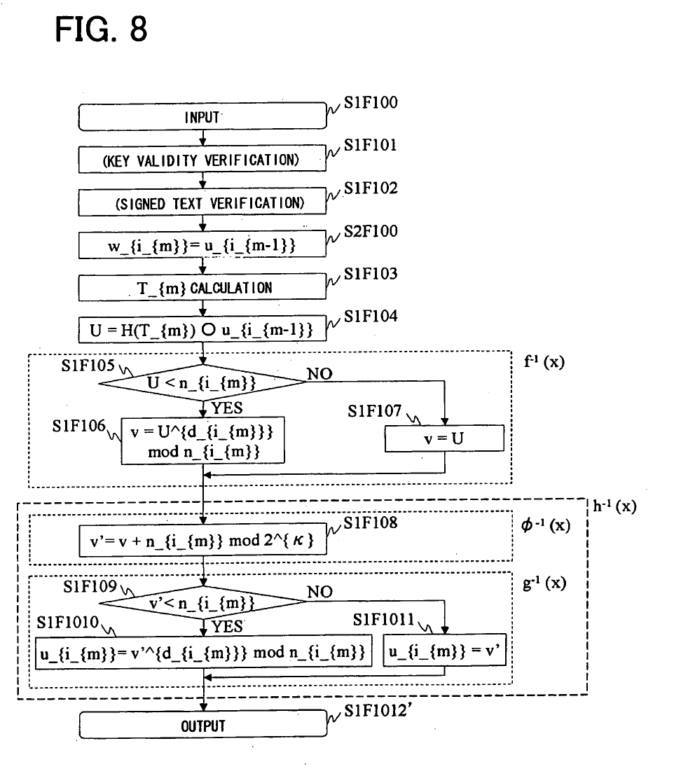

The method, which is used by the signature device i_{m} to sign the message M_{m} when the messages M_{—}{1}, . . . , M_{m}, the signed text u_{i_{m−1}} created by the signature devices i_{—}{1}, . . . , i_{m−1} for the messages M_{—}{1}, . . . , M_{m−1} using the public keys pk_{i_{—}{1}}, . . . , pk_{i_{m−1}}, and the auxiliary information w_{i_m−1}} are entered into the signature device i_{m}, is similar to that of the first embodiment except that the procedure for creating the auxiliary information is added. The following describes this method with reference to FIG. 7 and FIG. 8. In this embodiment, the signature device i_{m} calculates w_{i_{m}}=u_{i_{m−1}} after the processing in step S1F102 via the w setting means S2B100 and writes the calculation result into the storage medium S1B108 (S2F100). The auxiliary information w_{i_{m}} written into the storage medium S1B108, as well as the signed text u_{i_{m}}, created according to the same procedure as that of the first embodiment and written into the storage medium S1B108, is read by the output means S1B109 and is output (S1F10102′).

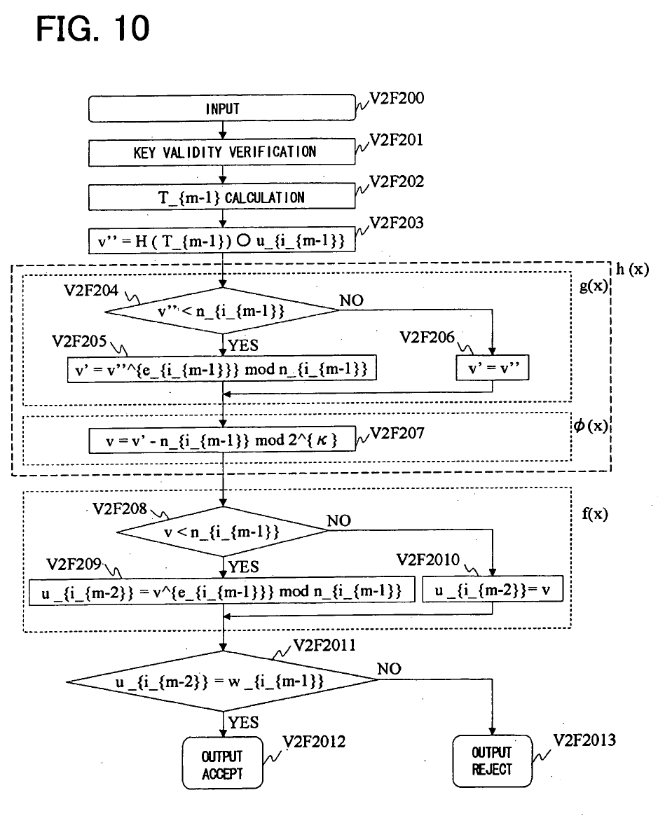

Next, with reference to FIG. 9 and FIG. 10, the following describes the method used by the verification device i_{m}−2 to verify the signed text u_{m−1}.

First, via the input means V2B200, the verification device i_{m}−2 reads pk_{i_{—}{1}}, . . . , pk_{i_{m−1}} from the public key storage device i_{m}−3, reads the messages M_{—}{1}, . . . , M_{m−1}, and saves them into the storage medium V2B2010 (V2F200).

Next, via the input means V2B200, the verification device i_{m}−2 sends pk_{i_{—}{1}}, . . . , pk_{i_{m−1}} to the key verification device i_{m}−4 and requests it to verify the validity of the public keys pk_{i_{—}{1}}, . . . , pk_{i_{m−1}} (V2F201).

Next, via the T_{m−1} calculation means V2B202, the verification device i_{m}−2 reads necessary data from the storage medium V2B2010, calculates T_{m−1}=M_{—}{1}∥ . . . ∥M_{m−1}∥pk_{i_{—}{1}}∥ . . . ∥pk_{i_{m−1}}, and saves the calculation result T_{m−1} into the storage medium V2B2010 (V2F202).

Next, via the v″ calculation means V2B203, the verification device i_{m}−2 reads necessary data from the storage medium V2B2010, calculates v″=H(T_{m−1})◯u_{i_{m−1}}, and saves the calculation result v″ into the storage medium V2B2010 (V2F203).

Next, via the second conversion means V2B204, the verification device i_{m}−2 reads necessary data from the storage medium V2B2010 and checks if v″<n_{i_{m−1}} (V2F204). If v″<n_{i_{m−1}}, the verification device i_{m}−2 calculates v′=v″̂{e_{i_{m−1}}} mod n_{i_{m−1}} via second conversion means V2B204 and saves the calculation result v′ into the storage medium V2B2010 (V2F205). On the other hand, if v″<n_{i_{m−1}} is not satisfied, the verification device i_{m}−2 performs the calculation with v′=v″ and saves the calculation result v′ into the storage medium V2B2010 (V2F206).

Next, via the bijective conversion means V2B205, the verification device i_{m}−2 reads necessary data from the storage medium V2B2010, calculates v=v′−n_{i_{m−1}} mod 2̂{κ}, and saves the calculation result v into the storage medium V2B2010 (V2F207).

Next, via the first conversion means V2B206, the verification device i_{m}−2 reads necessary data from the storage medium V2B2010 and checks if v<n_{i_{m−1}} (V2F208). If v<n_{i_{m−1}}, the verification device i_{m}−2 calculates u_{i_{m−2}}=v̂{e_{i_{m−1}}} mod n_{i_{m−1}}} via the first conversion means V2B206 and saves the calculation result u_{i_{m−2}} into the storage medium V2B2010 (V2F209). On the other hand, if u_{i_{m−2}}<n_{i_{{m−1}} is not satisfied, the verification device i_{m}−2 performs the calculation with u_{i_{m−1}}}=v and saves the calculation result u_{i_{m−2}} into the storage medium V2B2010 (V2F2010).

Next, via the u checking means V2B2011, the verification device i_{m}−2 reads necessary data from the storage medium V2B2010 and checks if u_{i_{m−2}}}=w_{i_{m−1}} (V2F2011). If u_{i_{m−2}}}=w_{i_{m−1}}, the verification device i_{m}−2 outputs accept via the accept output means V2B208 (V2F2012); otherwise, the verification device i_{m}−2 outputs reject via the reject output means V2B209 (V2F2013).

Next, the following describes the effects of this embodiment.

The first effect is that the signature length does not depend on the number of signature devices. The reason is that the number of bits of the data before being signed is equal to the number of bits of the data after being signed. However, the data is longer than that in the first embodiment by the length of the auxiliary information.

The second effect is that the calculation amount required for the verification calculation is less than that in the first embodiment. The reason is that, while the first embodiment requires the verification calculation proportional to the number of signature devices that have signed because the initial value must finally be obtained, this embodiment is required to perform verification calculation only for one signature device because the signed text that is input to the immediately preceding signature device is passed as the auxiliary information. Note that this embodiment assumes that the immediately preceding signature device is reliable. Therefore, the safety of this embodiment is lower than that of the first embodiment that assures safety without such an assumption.

The other effects of the first embodiment are also achieved.

Although the signed text u_{i_{j−1}} that is input to the signature device i_{j} is used as the auxiliary information w_{i_{j}}, which is paired with the signed text u_{i_{j}}, in this embodiment, it is also possible that the hash value h(u_{i_{j−1}}) of u_{i_{—{j-}1}} is used as the auxiliary information w_{i_{j}} where h is a predetermined hash function that outputs a hash value of the same number of bits as that of the input. The additional changes that are made to the first embodiment are also possible in this embodiment.

While the preferred embodiments of the present invention have been described, it is to be understood that the present invention is not limited to the embodiments but various additional changes are possible. The function of the signature device and the verification device of the present invention can be implemented not only by hardware but also by a computer program. The program, recorded in a computer readable recording medium such as a magnetic disk or semiconductor memory for distribution, is read by a computer when the computer is started. The operation of the computer is controlled to allow the computer to function as the signature device and the verification device described in the embodiments.

1. A signature method for use by a signature device that receives an initial value or a signed text, which is created by sequentially performing a signature operation by other plurality of signature devices, messages, and a private key of said signature device and that outputs a signed text equal in length to an input, wherein said output signed text indicates that the signature devices concerned with the creation of said output signed text, have signed the message input to each of the signature devices.

2. The signature method according to claim 1, wherein an operation of calculating the signed text has a first step and a second step;
an inverse function of a trapdoor one-way replacement is used for a calculation of the first step (operation of a part indicated by f̂{−1});
an inverse function of a trapdoor one-way replacement that is the same as, or different from, the trapdoor one-way replacement in the first step is used for a calculation of the second step (operation of a part indicated by ĥ{−1});
a calculation result is stored into a storage medium after the first step is terminated; and
necessary data is read from the storage medium when the second step is started, and a calculation result is stored in the storage medium after the second step is terminated.

3. The signature method according to claim 2, wherein, if an input to the first step is an element of a range of the trapdoor one-way replacement in the first step, the input is, mapped by the inverse function of the trapdoor one-way replacement but, if not, no operation is performed; and
wherein, if an input to the second step is an element of a range of the trapdoor one-way replacement, the input is mapped by the inverse function of the trapdoor one-way replacement but, if not, no operation is performed.

4. The signature method according to claim 3, wherein the calculation of the trapdoor one-way replacement used in the second step further comprises a first sub-step and a second sub-step;
wherein, in the first sub-step (operation of a part indicated by (φ̂{−1}), a bijection in a space of a whole signed text is calculated, the bijection can be calculated in polynomial time, and an inverse function of the bijection can also be calculated in polynomial time; and,
in the second sub-step (operation of a part indicated by ĝ{−1}), the inverse function of the trapdoor one-way replacement is used and, if an input to the second sub-step is an element of a range of the trapdoor one-way replacement, the input is mapped by an inverse function of the trapdoor one-way replacement but, if not, no operation is performed, and wherein necessary data is read from said storage medium when the first sub-step and the second sub-step are started and a calculation result is written into said storage medium when the first sub-step and the second sub-step are terminated.

5. The signature method according to claim 4, wherein the trapdoor one-way replacement used in the first step and the trapdoor one-way replacement used in the second sub-step of the second step are RSA functions.

6. The signature method according to claim 5, wherein the bijection used in the first sub-step of the second step is expressed as φ(x)=x−n_{i_{m}} mod 2̂{κ} where the n_{i_{m}} is an RSA modulus that is a part of a public key of the signature device i_{m} and the K is a security parameter.

7. The signature method according to claim 6, wherein said first step is preceded by a T_{m} calculation step in which T_{m}=M_{—}{1}∥ . . . ∥M_{m}∥pk_{i_{—}{1}}∥ . . . ∥pk_{i_{m}} is calculated where, for each j, the M_{—}{1}, . . . , M_{j} are messages input to a j-th signature device and the pk_{i_{j}} is a public key of a signature device i_{j}.

8. The signature method according to claim 7, wherein said first step is preceded by an exclusive OR calculation step in which U=H(T_{m})◯u_{i_{m−1}} is calculated where the H is a hash function, the u_{i_{m−1}} is the entered signed text, and ◯ is an exclusive OR.

9. The signature method according to claim 8, wherein said first step is preceded by a key validity verification step in which a check is made if pk_{i_{—}{1}}, . . . , pk_{i_{m−1}} are all different except when m=1 in which case no check is made.

10. The signature method according to claim 9, wherein said first step is preceded by a signed text verification step in which a received signed text is verified.

11. The signature method according to claim 8, wherein said first step is preceded both by a key validity verification step in which a check is made if pk_{i_{—}{1}}, . . . , pk_{i_{m−1}} are all different and by a signed text verification step in which a received signed text is verified.

12. The signature method according to any one of claims 1-11, further comprising the step of creating the initial value or the signed text, which is input, or a hash value thereof as auxiliary information that is output on said storage medium, wherein the auxiliary information and the signed text are output as a pair.

13. A signature method comprising the steps of:
receiving, by input means, an initial value or a signed text u_{i_{m−1}}, which is created by other plurality of signature devices that sequentially perform a signature operation, and messages M_{—}{1}, . . . , M_{m−1} entered into the signature devices and saving the initial value or the signed text and the messages into a storage medium;
reading, by T_{m} calculation means, necessary data from said storage medium and a public key storage device, calculating T_{m}=M_{—}{1}∥ . . . ∥M_{m}∥pk_{i_{—}{1}}∥ . . . ∥pk_{i_{m}} where pk_{i_{j}} is a public key of a signature device i_{j} and ∥ is a concatenation of bit strings, and saving the calculation result into said storage medium;
reading, by exclusive OR calculation means, necessary data from said storage medium, calculating U=H(T_{m})◯u_{i_{m−1}} where H is a hash function and ◯ is an exclusive OR, and saving the calculation result into said storage medium;
reading, by first conversion means, necessary data from said storage medium, calculating v=û{d_{i_{m}}} mod n_{i_{m}} if U<n_{i_{m}} where n_{i_{m}} is an RSA modulus of said signature device, calculating v=U if U≧n_{i_{m}}, and saving the calculation result into said storage medium;
reading, by bijective conversion means, necessary data from said storage medium, calculating v′=v+n_{i_{m}} mod 2̂{κ} where κ is a security parameter, and saving the calculation result into the storage medium;
reading, by second conversion means, necessary data from said storage medium, calculating u_{i_{m}}=v′̂{d_{i_{m}}} mod n_{i_{m}} if v′<n_{i_{m}}, calculating u_{i_{m}}=v′ if v′≧n_{i_{m}}, and saving the calculation result into said storage medium; and
reading, by output means, u_{i_{m}} from said storage medium and outputting u_{i_{m}} as the signed text.

14. The signature method according to claim 13, further comprising the step of:
calculating, by w setting means, w_{i_{m}}=u_{i_{m−1}} or w_{i_{m}}=h(u_{i_{m−1}}) where h is a hash function and saving the calculation result into said storage medium, wherein the created signed text u_{i_{m}}, which is paired with the calculated w_{i_{m}}, is output with w_{i_{m}} as auxiliary information.

15. A verification method for use by a verification device that verifies if a signed text u, which is created by sequentially performing a signature operation by a plurality of signature devices, wherein the verification is passed when and only when the signed text u is created by signature devices, which have been concerned with a creation of the signed text that is output, that have signed the message entered into each of the signature devices and wherein a number of bits of the signed text u is a constant that does not depend on a number of the signature devices which have been concerned with a calculation of the signed text u.

16. A verification method for use by a verification device that verifies if a signed text u, which is created by sequentially performing a signature operation by a plurality of signature devices, wherein the verification is passed when and only when the signature devices, which create the signed text u, create the signed text u in a valid method, wherein a number of bits of the signed text u is a constant that does not depend on a number of the signature devices which have been concerned with a calculation of the signed text u, and wherein the verification of the signed text u is performed using auxiliary information w that is data before a last one of the plurality of signature devices performs the signature operation.

17. The verification method according to claim 15 or 16, wherein an operation of verifying the signed text has a first step and a second step;
a trapdoor one-way replacement is used for a calculation of the first step (operation of a part indicated by h);
a trapdoor one-way replacement that is the same as, or different from, the trapdoor one-way replacement in the first step is used for a calculation of the second step (operation of a part indicated by f);
necessary data is read from a storage medium when the first step and the second step are started; and
a calculation result is written into the storage medium when the first step and the second step are terminated.

18. The verification method according to claim 17, wherein, in the first step, if an input to the first step is an element of a domain of the trapdoor one-way replacement, the input is mapped by the trapdoor one-way replacement but, if not, no operation is performed; and
wherein, if an input to the second step is an element of a domain of the trapdoor one-way replacement, the input is mapped by the trapdoor one-way replacement but, if not, no operation is performed.

19. The verification method according to claim 18, wherein the calculation of the trapdoor one-way replacement used in the first step further comprises a first sub-step and a second sub-step;
wherein, in the first sub-step (operation of a part indicated by g), a trapdoor one-way replacement function is used and, if an input to the first sub-step is an element of a range of the trapdoor one-way replacement, the input is mapped by the trapdoor one-way replacement function but, if not, no operation is performed;
wherein, in the second sub-step (operation of a part indicated by φ), a bijection in a space of a whole signed text is calculated, the bijection can be calculated in polynomial time, and an inverse function of the bijection can also be calculated in polynomial time; and
wherein necessary data is read from said storage medium when the first sub-step and the second sub-step are started and a calculation result is written into said storage medium when the first sub-step and the second sub-step are terminated.

20. The verification method according to claim 19, wherein the trapdoor one-way replacement used in the first sub-step of the first step and the trapdoor one-way replacement used in the second step are RSA functions.

21. The verification method according to claim 20, wherein the bijection used in the second sub-step of the first step is expressed as φ(x)=x+n_i_{m} mod 2̂{κ} where the n_{i_{m}} is an RSA modulus that is a part of a public key of the signature device i_{m} and the κ is a security parameter.

22. The verification method according to claim 21, wherein said second step is followed by a T_{j} calculation step in which T_{j}=M_{—}{1}∥ . . . ∥M_{j}∥pk_{i_{—}{1}}∥ . . . ∥pk_{i_{j}} is calculated where, for each j, the M_{—}{1}, . . . , M_{j} are messages input to a j-th signature device and the pk_{i_{j}} is a public key of a signature device i_{j}.

23. The verification method according to claim 22, wherein said T_{j} calculation step is followed by a u calculation step in which necessary data is read from said storage medium, u_{i_{j−1}}=H(T_{j})◯U is calculated and the calculation result is saved into said storage medium where H is a hash function and U is the calculation result of the second step.

24. The verification method according to claim 23, wherein said first step, said second step, said T_{j} calculation step, and said u calculation step are repeated for j=m−1, . . . , 1.

25. The verification method according to claim 24, wherein said first step, said second step, said T_{j} calculation step, and said u calculation step, which are repeated for j=m−1, . . . , 1, are preceded by a key validity verification step in which a check is made if pk_{i_{—}{1}}, . . . , pk_{i_{m−1}} are all different except when m=1 in which case no check is made.

26. The verification method according to claim 25, wherein said first step, said second step, said T_{j} calculation step, and said u calculation step, which are repeated for j=m−1, . . . , 1, are followed by a u checking step in which a check is made if an initial value is obtained as a result of the verification.

27. The verification method according to claim 21, wherein said first step is preceded by a T_{m−1} calculation step and a v″ calculation step, T_{m−1}=M_{—}{1}∥ . . . ∥M_{m−1}∥pk_{i_{—}{1}}∥ . . . ∥pk_{i_{m−1}} is calculated in said T_{m−1} calculation step, where M_{—}{1}, . . . , M_{m−1} are messages input to first, . . . , (m−1)th signature devices and the pk_{i_{j}} is a public key of a signature device i_{j}, and v″=H(T_{m−1})◯u_{i_{m−1}} is calculated in said v″ calculation step and wherein said first step receives the v″; and
wherein said second step is followed by a u checking step in which a check is made if a calculation result of said second step matches the auxiliary information.

28. A verification method comprising the steps of:
receiving, by input means, a signed text u_{i_{m−1}}, which is created by one or more other signature devices that sequentially perform a signature operation, messages M_{—}{1}, . . . , M_{m−1} entered into the signature devices, and public keys pk_{i_{—}{1}}, . . . , pk_{i_{m−1}} and saving the signed text, the messages, and the public keys into a storage medium;
setting, by j initialization means, m−1 in a variable j;
reading, by second conversion means, necessary data from said storage medium, calculating v′=u_{i_{j}}̂{e_{i_{j}}} mod n_{i_{j}} if u_{i_{j}}<n_{i_{j}}, calculating v′=u_{i_{j} if u_{i_{j}}≧n_{i_{j}}, and saving the calculation result into said storage medium;
reading, by bijective calculation means, necessary data from said storage medium, calculating v=v′−n_{i_{m}} mod 2̂{κ}, and saving the calculation result into said storage medium;
reading, by first conversion means, necessary data from said storage medium, calculating U=v̂{e_{i_{j}}} mod n_{i_{j}} if v<n_{i_{j}}, calculating U=v if v≧n_{i_{j}}, and saving the calculation result into said storage medium;
repeating, by said second conversion means, said bijection calculation means, and said first conversion means, the steps each time the variable j is decremented by one until the variable j reaches 0;
reading, by T_{j} calculation means, necessary data from said storage medium, calculating T_{j}=M_{—}{1}∥ . . . ∥M_{j}∥pk_{i_{—}{1}}∥ . . . ∥pk_{i_{j}}, and saving the calculation result into said storage medium;
reading, by u calculation means, necessary data from said storage medium, calculating u_{i_{j−1}}=H(T_{j})◯U, and saving the calculation result into said storage medium;
reading, by u checking means, necessary data from said storage medium and checking if u is a predetermined initial value; and
outputting, by output means, a verification success notification if u is the predetermined initial value and, if not, outputting a verification failure notification.

29. A verification method comprising the steps of:
receiving, by input means, a signed text u_{i_{m−1}}, which is created by one or more other signature devices that sequentially perform a signature operation, auxiliary information v_{i_{m−1}} that is a signed text entered by an immediately preceding signature device or a hash value thereof, messages M_{—}{1}, . . . , M_{m−1} entered into the signature devices, and public keys pk_{i_{—}{1}}, . . . , pk_{i_{m−1}} of the signature devices and saving the signed text, the auxiliary information, the messages, and the public keys into a storage medium;
reading, by T_{m−1} calculation means, necessary data from said storage medium, calculating T_{m−1}=M_{—}{1}∥ . . . ∥M_{m−1}∥pk_{i_{—}{1}}∥ . . . ∥pk_{i_{m−1}}, and saving the calculation result into said storage medium;
reading, by v″ calculation means, necessary data from said storage medium, calculating v″=H(T_{m−1})◯u_{i_{m−1}}, and saving the calculation result into said storage medium;
reading, by second conversion means, necessary data from said storage medium, calculating v′=v″̂{e_{i_{m−1}}} mod n_{i_{m−1}} if v″<n_{i_{m−1}}, calculating v′=v″ if V″≧n_{i_{m−1}}, and saving the calculation result into said storage medium;
reading, by bijective calculation means, necessary data from said storage medium, calculating v=v′−n_{i_{m−1}} mod 2̂{κ}, and saving the calculation result into the storage medium;
reading, by first conversion means, necessary data from said storage medium, calculating u_{i_{m−2}}=v̂{e_{i_{m−1}}} mod n_{i_{m−1}} if v<n_{i_{m−1}}, calculating u_{i_{m−2}}=v if v≧n_{i_{m−1}}, and saving the calculation result into said storage medium;
reading, by u checking means, necessary data from said storage medium and checking if u_{i_{m−2}} or a hash value thereof matches the auxiliary information v_{i_{m−1}}; and
outputting, by output means, a verification success notification if u_{i_{m−2}} or a hash value thereof matches the auxiliary information v_{i_{m−1}} and, if not, outputting a verification failure notification.

30. A signature device comprising:
a readable/writable storage medium;
input means that receives an initial value or a signed text u_{i_{m−1}}, which is created by other plurality of signature devices that sequentially perform a signature operation, and messages M_{—}{1}, . . . , M_{m−1} entered into the signature devices and saves the initial value or the signed text and the messages into said storage medium;
T_{m} calculation means that reads necessary data from said storage medium and a public key storage device, calculates T_{m}=M_{—}{1}∥ . . . ∥M_{m}∥pk_{i_{—}{1}}∥ . . . ∥pk_{i_{m}} where pk_{i_{j}} is a public key of a signature device i_{j} and ∥ is a concatenation of bit strings, and saves the calculation result into said storage medium;
exclusive OR calculation means that reads necessary data from said storage medium, calculates U=H(T_{m})◯u_{i_{m−1}} where H is a hash function and ◯ is an exclusive OR, and saves the calculation result into said storage medium;
first conversion means that reads necessary data from said storage medium, calculates v=û{d_{i_{m}}} mod n_{i_{m}} if U<n_{i_{m}} where n_{i_m}} is an RSA modulus of said signature device, calculates v=U if U≧n_{i_{m}}, and saves the calculation result into said storage medium;
bijective conversion means that reads necessary data from said storage medium, calculates v′=v+n_{i_{m}} mod 2̂{κ} where κ is a security parameter, and saves the calculation result into the storage medium;
second conversion means that reads necessary data from said storage medium, calculates u_{i_{m}}=v′̂{d_{i_{m}}} mod n_{i_{m}} if v′<n_{i_{m}}, calculates u_{i_{m}}=v′ if v′≧n_{i_{m}}, and saves the calculation result into said storage medium; and
output means that reads u_{i_{m}} from said storage medium and outputs u_{i_{m}} as the signed text.

31. The signature device according to claim 30, further comprising w setting means that calculates w_{i_{m}}=u_{i_{m−1}} or w_{i_{m}}=h(u_{i_{m−1}}) where h is a hash function and saves the calculation result into said storage medium, wherein the created signed text u_{i_{m}}, which is paired with the calculated w_{i_{m}}, is output with w_{i_{m}} as auxiliary information.

32. A verification device comprising:
a readable/writable storage medium;
input means that reads a signed text u_{i_{m−1}}, which is created by one or more other signature devices that sequentially perform a signature operation, messages M_{—}{1}, . . . , M_{m−1} entered into the signature devices, and public keys pk_{i_{—}{1}}, . . . , pk_{i_{m−1}} and saves the signed text, the messages, and the public keys into said storage medium;
j initialization means that sets m−1 in a variable j;
second conversion means that reads necessary data from said storage medium, calculates v′=u_{i_{j}}̂{e_{i_{j}}} mod n_{i_{j} if u_{i_{j}}<n_{i_{j}}, calculates v′=u_{i_{j} if u_{i_{j}}≧n_{i_{j}}, and saves the calculation result into said storage medium;
bijective calculation means that reads necessary data from said storage medium, calculates v=v′−n_{i_{m}} mod 2̂{κ}, and saves the calculation result into said storage medium;
first conversion means that reads necessary data from said storage medium, calculates U=v̂{e_{i_{j}}} mod n_{i_{j}} if v<n_{i_{j}}, calculates U=v if v≧n_{i_{j}}, and saves the calculation result into said storage medium;
T_{j} calculation means that reads necessary data from said storage medium, calculates T_{j}=M_{—}{1}∥ . . . ∥M_{j}∥pk_{i_{—}{1}}∥ . . . ∥pk_{i_{j}}, and saves the calculation result into said storage medium after said second conversion means, said bijection calculation means, and said first conversion means repeat the steps each time the variable j is decremented by one until the variable j reaches 0;
u calculation means that reads necessary data from said storage medium, calculates u_{i_{j−1}}=H(T_{j})◯U, and saves the calculation result into said storage medium;
u checking means that reads necessary data from said storage medium and checks if u is a predetermined initial value; and
output means that outputs a verification success notification if u is the predetermined initial value and, if not, outputs a verification failure notification.

33. A verification device comprising:
a readable/writable storage medium;
input means that receives a signed text u_{i_{m−1}}, which is created by one or more other signature devices that sequentially perform a signature operation, auxiliary information v_{i_{m−1}} that is a signed text entered by an immediately preceding signature device or a hash value thereof, messages M_{—}{1}, . . . , M_{m−1} entered into the signature devices, and public keys pk_{i_{—}{1}}, . . . , pk_{i_{m−1}} of the signature devices and saves the signed text, the auxiliary information, the messages, and the public keys into said storage medium;
T_{m−1} calculation means that reads necessary data from said storage medium, calculates T_{m−1}=M_{—}{1}∥ . . . ∥M_{m−1}∥pk_{i_{—}{1}}∥ . . . ∥pk_{i_{m−1}}, and saves the calculation result into said storage medium;
v″ calculation means that reads necessary data from said storage medium, calculates v″=H(T_{m−1})◯u_{i_{m−1}}, and saves the calculation result into said storage medium;
second conversion means that reads necessary data from said storage medium, calculates v′=v″̂{e_{i_{m−1}}} mod n_{i_{m−1}} if v″<n_{i_{m−1}}, calculates v′=v″ if V″≧n_{i_{m−1}}, and saves the calculation result into said storage medium;
bijective calculation means that reads necessary data from said storage medium, calculates v=v′−n_{i_{m−1}} mod 2̂{κ}, and saves the calculation result into the storage medium;
first conversion means that reads necessary data from said storage medium, calculates u_{i_{m−2}}=v̂{e_{i_{m−1}}} mod n_{i_{m−1}} if v<n_{i_{m−1}}, calculates u_{i_{m−2}}=v if v≧n_{i_{m−1}}, and saves the calculation result into said storage medium;
u checking means that reads necessary data from said storage medium and checks if u_{i_{m−2}} or a hash value thereof matches the auxiliary information v_{i_{m−1}}; and
output means that outputs a verification success notification if u_{i_{m−2}} or a hash value thereof matches the auxiliary information v_{i_{m−1}} and, if not, outputs a verification failure notification.

34. A program that causes a computer having a readable/writable storage medium to function as:
input means that receives an initial value or a signed text u_{i_{m−1}}, which is created by other plurality of signature devices that sequentially perform a signature operation, and messages M_{—}{1}, . . . , M_{m−1} entered into the signature devices and saves the initial value or the signed text and the messages into said storage medium;
T_{m} calculation means that reads necessary data from said storage medium and a public key storage device, calculates T_{m}=M_{—}{1}∥ . . . ∥M_{m}∥pk_{i_{—}{1}}∥ . . . ∥pk_{i_{m}} where pk_{i_{j}} is a public key of a signature device i_{j} and ∥ is a concatenation of bit strings, and saves the calculation result into said storage medium;
exclusive OR calculation means that reads necessary data from said storage medium, calculates U=H(T_{m})◯u_{i_{m−1}} where H is a hash function and ◯ is an exclusive OR, and saves the calculation result into said storage medium;
first conversion means that reads necessary data from said storage medium, calculates v=û{d_{i_{m}}} mod n_{i_{m}} if U<n_{i_{m}} where n_{i_m}} is an RSA modulus of said signature device, calculates v=U if U≧n_{i_{m}}, and saves the calculation result into said storage medium;
bijective conversion means that reads necessary data from said storage medium, calculates v′=v+n_{i_{m}} mod 2̂{κ} where κ is a security parameter, and saves the calculation result into the storage medium;
second conversion means that reads necessary data from said storage medium, calculates u_{i_{m}}=v′̂{d_{i_{m}}} mod n_{i_{m}} if v′<n_{i_{m}}, calculates u_{i_{m}}=v′ if v′≧n_{i_{m}}, and saves the calculation result into said storage medium; and
output means that reads u_{i_{m}} from said storage medium and outputs u_{i_{m}} as the signed text.

35. The program according to claim 34, further causing the computer to function as w setting means that calculates w_{i_{m}}=u_{i_{m−1}} or w_{i_{m}}=h(u_{i_{m−1}}) where h is a hash function and saves the calculation result into said storage medium, wherein the created signed text u_{i_{m}}, which is paired with the calculated w_{i_{m}}, is output with w_{i_{m}} as auxiliary information.

36. A program that causes a computer having a readable/writable storage medium to function as:
input means that reads a signed text u_{i_{m−1}}, which is created by one or more other signature devices that sequentially perform a signature operation, messages M_{—}{1}, . . . , M_{m−1} entered into the signature devices, and public keys pk_{i_{—}{1}}, . . . , pk_{i_{m−1}} and saves the signed text, the messages, and the public keys into said storage medium;
j initialization means that sets m−1 in a variable j;
second conversion means that reads necessary data from said storage medium, calculates v′=u_{i_{j}}̂{e_{i_{j}}} mod n_{i_{j}} if u_{i_{j}}<n_{i_{j}}, calculates v′=u_{i_{j} if u_{i_{j}}≧n_{i_{j}}, and saves the calculation result into said storage medium;
bijective calculation means that reads necessary data from said storage medium, calculates v=v′−n_{i_{m}} mod 2̂{κ}, and saves the calculation result into said storage medium;
first conversion means that reads necessary data from said storage medium, calculates U=v̂{e_{i_{j}}} mod n_{i_{j}} if v<n_{i_{j}}, calculates U=v if v≧n_{i_{j}}, and saves the calculation result into said storage medium;
T_{j} calculation means that reads necessary data from said storage medium, calculates T_{j}=M_{—}{1}∥ . . . ∥M_{j}∥pk_{i_{—}{1}}∥ . . . ∥pk_{i_{j}}, and saves the calculation result into said storage medium after said second conversion means, said bijection calculation means, and said first conversion means repeat the steps each time the variable j is decremented by one until the variable j reaches 0;
u calculation means that reads necessary data from said storage medium, calculates u_{i_{j−1}}=H(T_{j})◯U, and saves the calculation result into said storage medium;
u checking means that reads necessary data from said storage medium and checks if u is a predetermined initial value; and
output means that outputs a verification success notification if u is the predetermined initial value and, if not, outputs a verification failure notification.

37. A program that causes a computer having a readable/writable storage medium to function as:
input means that receives a signed text u_{i_{m−1}}, which is created by one or more other signature devices that sequentially perform a signature operation, auxiliary information v_{i_{m−1}} that is a signed text entered by an immediately preceding signature device or a hash value thereof, messages M_{—}{1}, . . . , M_{m−1} entered into the signature devices, and public keys pk_{i_{—}{1}}, . . . , pk_{i_{m−1}} of the signature devices and saves the signed text, the auxiliary information, the messages, and the public keys into said storage medium;
T_{m−1} calculation means that reads necessary data from said storage medium, calculates T_{m−1}=M_{—}{1}∥ . . . ∥M_{m−1}∥pk_{i_{—}{1}}∥ . . . ∥pk_{i_{m−1}}, and saves the calculation result into said storage medium;
v″ calculation means that reads necessary data from said storage medium, calculates v″=H(T_{m−1})◯u_{i_{m−1}}, and saves the calculation result into said storage medium;
second conversion means that reads necessary data from said storage medium, calculates v′=v″̂{e_{i_{m−1}}} mod n_{i_{m−1}} if v″<n_{i_{m−1}}, calculates v′=v=″ if V″≧n_{i_{m−1}}, and saves the calculation result into said storage medium;
bijective calculation means that reads necessary data from said storage medium, calculates v=v′−n_{i_{m−1}} mod 2̂{κ}, and saves the calculation result into the storage medium;
first conversion means that reads necessary data from said storage medium, calculates u_{i_{m−2}}=v̂{e_{i_{m−1}}} mod n_{i_{m−1}} if v<n_{i_{m−1}}, calculates u_{i_{m−2}}=v if v≧n_{i_{m−1}}, and saves the calculation result into said storage medium;
u checking means that reads necessary data from said storage medium and checks if u_{i_{m−2}} or a hash value thereof matches the auxiliary information v_{i_{m−1}}; and
output means that outputs a verification success notification if u_{i_{m−2}} or a hash value thereof matches the auxiliary information v_{i_{m−1}} and, if not, outputs a verification failure notification.

38. A signature device comprising at least means that, when an initial value or a signed text which is created by other plurality of signature devices that sequentially perform a signature operation, and messages entered into the signature devices are received, calculates a result of a concatenation between the messages and a public key of the signature device and public keys of already-signed signature devices and derives an exclusive OR between a hash value of the result of the concatenation and the signed text, said signature device further comprising:
first means that directly outputs the exclusive OR if the exclusive OR exceeds an RSA modulus that is a part of the public key of said signature device and, if not, outputs a result produced by adding an RSA-signature-based signature to the exclusive OR;
second means that multiples an output of said first means by a function that maps the output to a value larger by the RSA modulus; and
third conversion means that directly outputs an operation result of said bijection means if an operation result of said second means exceeds the RSA modulus and, if not, outputs a result produced by adding an RSA-signature-based signature to the operation result of said second means.

39. A verification device that verifies if a signed text created by a plurality of signature devices set forth in claim 38, that sequentially perform a signature operation, is valid, said verification device verifying a signature produced by each signature device, said verification device comprising:
fourth means that directly outputs the signed text if the signed text exceeds an RSA modulus of a corresponding signature device and, if not, outputs a result produced by adding an RSA-signature-based signature;
fifth means that multiples an output of said fourth means by a function that maps the output to a value smaller by the RSA modulus;
sixth means that directly outputs an output of said fifth means if an output of said fifth means exceeds the RSA modulus and, if not, outputs a result produced by adding an RSA-signature-based signature to the output of said fifth means; and
seventh means that calculates an exclusive OR between a hash value of a result of a concatenation, which is between messages entered into the signature devices and a public key of the signature device and public keys of already-signed signature devices, and an output of said sixth means,
wherein whether the verification is successful or unsuccessful is determined based on an output result of said seventh means for each of the signature devices.
